(19) United States
(12) Patent Application Publication
(10) Pub. No.: US 2022/0280933 A1
(43) Pub. Date: Sep. 8, 2022

(54) DEVICES, SYSTEMS, AND METHODS FOR GENERATING DROPLETS

(71) Applicant: 10x Genomics, Inc., Pleasanton, CA (US)

(72) Inventors: Rajiv BHARADWAJ, Pleasanton, CA (US); Hanyoup KIM, Foster City, CA (US); Bill Kengli LIN, Pleasanton, CA (US); Marissa PENNELL, San Ramon, CA (US); Alireza SALMANZADEH, San Francisco, CA (US); Martin SAUZADE, Pleasanton, CA (US); Tobias Daniel WHEELER, Pleasanton, CA (US)

(21) Appl. No.: 17/751,267

(22) Filed: May 23, 2022

Related U.S. Application Data
(63) Continuation of application No. PCT/US2020/062195, filed on Nov. 25, 2020.
(60) Provisional application No. 62/941,396, filed on Nov. 27, 2019.

(51) Int. Cl. B01L 3/02; B01L 3/00

(52) U.S. Cl. CPC B01L 3/0268; B01L 3/502761; B01L 3/502769; B01L 2200/0673; B01L 2300/165; B01L 2400/021; B01L 2400/0439

(57) ABSTRACT

Devices, systems, and their methods of use, for generating droplets are provided. The devices, systems, and methods may include transporting a first liquid through an outlet of a channel and causing relative motion of the outlet and an interface of a second liquid to produce droplets of the first liquid in the second liquid. The devices, systems, and methods may also include illuminating a portion of the liquid as the liquid exits from an outlet. The invention also provides methods, devices, and systems for changing the size of a droplet and for eliminating a droplet from a plurality of droplets.

### BACKGROUND OF THE INVENTION

Many biomedical applications rely on high-throughput assays of samples combined with one or more reagents in droplets. For example, in both research and clinical applications, high-throughput genetic tests using target-specific reagents are able to provide information about samples in drug discovery, biomarker discovery, and clinical diagnostics, among others. Furthermore, the use of fluidically-driven droplet generation has created a limit to the throughput of conventional droplet generation approaches and has provided a lack of control of the droplets after droplet generation.

Improved devices and methods for producing droplets would be beneficial.

### SUMMARY OF THE INVENTION

In one aspect, the invention features a method of producing droplets of a combination of a first and a third liquid. The method includes providing a device including a first channel having a first proximal end and a first distal end, wherein the first distal end is open to the exterior of the device; and a second channel having a second proximal end and a second distal end, wherein the first and second channels intersect between the first proximal and first distal ends; transporting a first liquid from the first proximal end to the intersection and a third liquid from the second proximal end to the intersection to form a combined fluid; and transporting the combined fluid to the first distal end and vibrating the device to form droplets as the combined liquid exits the device.

In some embodiments, the method further includes using a piezoelectric or acoustic actuator to vibrate the device. This amplitude of vibrating may be at most twice the width of the first distal end, e.g., about equal to the width of the first distal end.

In some embodiments, the first and third liquids are aqueous or miscible with water.

In some embodiments, the first or third liquid may include particles. These particles may be beads (e.g., gel beads) or biological particles (e.g., cells or nuclei). In other embodiments, the first liquid includes first particles, and the third liquid includes second particles. In some embodiments, a portion of the droplets includes one first and one second particle, e.g., a single first particle and a single second particle. In some embodiments, one of the first and second particles is beads (e.g., gel beads), and the other is biological particles (e.g., cells or nuclei).

In some embodiments of the method, the device further includes a third channel with a third proximal end and a third distal end, wherein the first and third channels intersect between the first proximal and first distal ends. In some embodiments, the second and third channels intersect the first channel in the same location. In some embodiments, the proximal ends of the second and third channels are connected, e.g., via a reservoir. Liquid in the third channel may be combined with other liquids at the intersection. The liquid in the third channel may be the second liquid or a different liquid.

In some embodiments, prior to droplet formation, the fluids are passed through the first and second channels at a rate higher than that of droplet formation.

In some embodiments, the exterior of the device around the first distal end includes a material that the combined fluid does not wet, e.g., the material is hydrophobic.

In some embodiments, the first distal end is submerged in an immiscible fluid during droplet formation.

In some embodiments, the device further includes at least one fourth channel having a proximal end and a distal end, wherein the fourth channel does not intersect the first or second channels, and the distal end of the fourth channel is open to the exterior of the device. A second liquid, immiscible with the first liquid, is transported from the proximal to the distal end of the fourth channel, wherein the liquid contacts the droplets.

In some embodiments, the exterior of the device around the fourth distal end includes a material that the second liquid does not wet, e.g., the material is hydrophilic or fluorophobic.

In an aspect, the invention features a method of producing droplets. The droplets may include a particle, e.g., a non-biological particle, such as a bead, a biological particle, such as a cell, or a combination thereof. The method may include providing a device including a first channel having an outlet, e.g., to the exterior of the device, and having a first liquid and a reservoir including a second liquid having an interface with a fluid. The first liquid may include particles (e.g., non-biological particles, biological particles, or a combination thereof). The method may include transporting the first liquid through the outlet and causing relative motion of the outlet and the interface to produce droplets of the first liquid and the particle in the second liquid. If the first liquid includes particles, the droplets formed may include particles.

In some embodiments, the method produces droplets in which a plurality of the droplets includes exactly one particle (e.g., non-biological particle). For example, the method may produce a population of droplets in which at least 50%, 60%, 70%, 80%, 90%, 95%, 97%, 99%, or 100% of the droplets include exactly one particle. The method may produce droplets in which a plurality of the droplets includes exactly one biological particle and exactly one non-biological particle.

In some embodiments, the reservoir includes a shunt configured to maintain a substantially constant vertical location of the interface as droplets are formed.

In some embodiments, the relative motion includes causing the interface to move while the outlet is stationary. In some embodiments, the relative motion includes moving the reservoir. In some embodiments, the interface is moved without moving the reservoir. In some embodiments, the relative motion includes activating an actuator operatively coupled to the second liquid resulting in movement of the interface. In some embodiments, the relative motion includes causing the outlet to move.

In some embodiments, the device further includes a second channel that intersects the first channel upstream of the outlet. In some embodiments, the second channel includes a third liquid, and the droplets produced include the first liquid, the third liquid, and the non-biological particle. In some embodiments, the third liquid includes a biological particle.

In some embodiments, the fluid is a fourth liquid immiscible with the second liquid.

In some embodiments, the device includes a plurality (e.g., 2, 3, 4, 5, 6, 7, 8, 9, or 10, or more) of the first channels. The first liquid may be transported through the outlet of each of the plurality of first channels, and the relative motion is with respect to the outlet of each of the plurality of first channels and the interface.

In another aspect, the invention features a system for producing droplets of a first liquid in a second liquid. The system includes a device including a first channel having an outlet and a reservoir including a second liquid having an interface with a fluid. The system is configured to cause relative motion of the outlet with respect to the interface so that the outlet crosses the interface. The reservoir may include a shunt configured to maintain a substantially constant vertical location of the interface as droplets are formed.

In another aspect, the invention features system for producing droplets of a first liquid in a second liquid. The system includes a device including a first channel having an outlet, a reservoir including a second liquid having an interface with a fluid, and an actuator operatively coupled to the second liquid to move the interface relative to the outlet. The system is configured to cause relative motion of the outlet with respect to the interface so that the outlet crosses the interface.

In some embodiments, the reservoir includes a shunt configured to maintain a substantially constant vertical location of the interface as droplets are formed.

In some embodiments, the device further includes a second channel that intersects the first channel upstream of the outlet. In some embodiments, the second channel includes a third liquid.

In some embodiments, the fluid is a fourth liquid immiscible with the second liquid.

In some embodiments, the system includes a plurality (e.g., 2, 3, 4, 5, 6, 7, 8, 9, or 10, or more) of the first channels.

In some embodiments, the actuator produces an acoustic or a mechanical wave.

In some embodiments, the system further includes a sensor configured to detect a vertical position of the interface in the second liquid.

In another aspect, the invention features a method of producing droplets of a first liquid in a second liquid. The method may include providing the system of any of the above embodiments and transporting the first liquid through the outlet and causing relative motion of the outlet and the interface to produce droplets of the first liquid in the second liquid.

In another aspect, the invention features a device including a first channel having a first proximal end and a first distal end, wherein the first distal end is open to the exterior of the device; and a second channel having a second proximal end and a second distal end, wherein the first and second channels intersect between the first proximal and first distal ends.

In some embodiments, the device further includes a vibration source. In some embodiments the vibration source is a piezoelectric or acoustic actuator.

In some embodiments, the device may further include a first reservoir in fluid communication with the first proximal end. In other embodiments, the device may further include a second reservoir in fluid communication with the second proximal end.

In some embodiments, the device further includes a third channel with a third proximal end and a third distal end, wherein the first and third channels intersect between the first proximal and first distal ends. In some embodiments the second and third channels may intersect the first channel in the same location. In other embodiments the proximal ends of the second and third channels may be connected, e.g., via the second reservoir. Liquid in the third channel may be combined with other liquids at the intersection. The liquid in the third channel may the second liquid or a different liquid.

In some embodiments, the device further may include at least one fourth channel having a proximal end and a distal end, wherein the fourth channel does not intersect the first or second channels, the distal end of the fourth channel is open to the exterior of the device and positioned to allow a second liquid passing there through to contact droplets formed at the distal end of the first channel. In some embodiments, the exterior of the device around the fourth distal end includes a material that the second liquid does not wet, e.g., the material is hydrophilic or fluorophobic.

In another aspect, the invention features a system for producing droplets including a device of the invention and a vibration source operatively coupled to the device.

In some embodiments, the system may further include a first liquid in the first channel and a third liquid in the second channel. In further embodiments, the first liquid may include first particles, and the third liquid may include second particles. In some embodiments, one of the first and second particles is beads (e.g., gel beads), and the other is biological particles (e.g., cells or nuclei).

In some embodiments, the system may further include a controller operatively coupled to transport the first and third liquids to the intersection to form a combined liquid and to transport the combined liquid to the first distal end.

In some embodiments of the system, the vibration source is a piezoelectric or acoustic actuator.

In some embodiments, the system may further include a first reservoir in fluid communication with the first proximal end. In other embodiments, the system may further include a second reservoir in fluid communication with the second distal end.

In some embodiments, the system may further include a collection reservoir disposed to collect droplets exiting from the first distal end. In other embodiments, the collection reservoir may include a second liquid with which the droplets are immiscible. In some embodiments, the first distal end may be submerged in the second liquid.

In some embodiments, the device may further include a third channel with a third proximal end and a third distal end, wherein the first and third channels intersect between the first proximal and first distal ends. In other embodiments, the second and third channels may intersect the first channel in the same location. In other embodiments, the proximal ends of the second and third channels are connected, e.g., via a second reservoir. Liquid in the third channel may be combined with other liquids at the intersection. The liquid in the third channel may be the second liquid or a different liquid.

In some embodiments, the vibration source may be operatively connected to the collection reservoir.

In some embodiments of the system, the device further includes at least one fourth channel having a proximal end and a distal end, wherein the fourth channel does not intersect the first or second channels, and the distal end of the fourth channel is open to the exterior of the device and positioned to allow liquid passing there through, e.g., second liquid, to contact droplets formed at the distal end of the first channel.

In some embodiments, the exterior of the device around the first distal end includes a material that the combined fluid does not wet, e.g., the material is hydrophobic. In some embodiments, the exterior of the device around the fourth distal end includes a material that the second liquid does not wet, e.g., the material is hydrophilic or fluorophobic.

In another aspect, the invention features a method of collecting droplets by (a) providing a device having a trough having an inlet and an outlet and including a second liquid; (b) allowing droplets of a first liquid to enter the trough as the second liquid flows from the inlet to the outlet, wherein the first and second liquids are immiscible with each other. In some embodiments the trough has a descending angle from inlet to outlet. The descending angle may be from about 1° to about 89° (e.g., from about 10° to about 80°, about 20° to about 70°, about 30° to about 60°, about 40° to about 50°, about 10° to about 20°, about 20° to about 30°, about 30° to about 40°, about 40° to about 50°, about 50° to about 60°, about 60° to about 70°, about 70° to about 80°, about 80° to about 89°).

In some embodiments, the flow rate of the second liquid is from about 150 μL/min to about 115 L/min (e.g., from about 250 μL/min to about 115 L/min, about 500 μL/min to about 115 L/min, about 750 μL/min to about 115 L/min, about 1000 μL/min to about 115 L/min, about 5 mL/min to about 115 L/min, about 10 mL/min to about 115 L/min, about 50 mL/min to about 115 L/min, about 100 mL/min to about 115 L/min, about 250 mL/min to about 115 L/min, about 500 mL/min to about 115 L/min, about 1 L/min to about 115 L/min, about 5 L/min to about 115 L/min, about 10 L/min to about 115 L/min, about 50 L/min to about 115 L/min, about 100 L/min to about 115 L/min, about 150 μL/min to about 100 L/min, about 150 μL/min to about 50 L/min, about 150 μL/min to about 10 L/min, about 150 μL/min to about 1 L/min, about 150 μL/min to about 500 mL/min, about 150 μL/min to about 100 mL/min, about 150 μL/min to about 1 mL/min, about 150 μL/min to about 500 μL/min, about 150 μL/min to about 250 μL/min, about 250 μL/min to about 100 L/min, about 500 μL/min to about 50 L/min, about 1000 μL/min to about 1 L/min, about 5 mL/min to about 500 mL/min, or about 100 mL/min to about 250 mL/min).

In some embodiments, the first liquid is less dense than the second liquid.

In some embodiments, the first liquid includes particles. The particles may be beads (e.g., gel beads) or biological particles (e.g., cells or nuclei).

In another aspect, the invention features a method of collecting droplets by (a) providing a moving plate including a second liquid; and (b) allowing droplets of a first liquid to contact the second liquid as the plate moves, wherein the droplets are transported away from the point of contact and the first and second liquids are immiscible with each other.

In some embodiments, the motion of the plate in step (a) is rotational. The speed of rotation of the plate may be from about 0.05 MHz to about 150 MHz (e.g., from about 0.1 MHz to about 150 MHz, about 0.5 MHz to about 150 MHz, about 1 MHz to about 150 MHz, about 5 MHz to about 150 MHz, about 10 MHz to about 150 MHz, about 50 MHz to about 150 MHz, about 100 MHz to about 150 MHz, about 0.05 MHz to about 100 MHz, about 0.05 MHz to about 50 MHz, about 0.05 MHz to about 10 MHz, about 0.05 MHz to about 1 MHz, about 0.05 MHz to about 0.1 MHz, about 0.1 MHz to about 100 MHz, about 1 MHz to about 50 MHz, about 5 MHz to about 50 MHz, about 10 MHz to about 20 MHz). In some embodiments, the motion of the plate in step (a) is oscillatory. The frequency of oscillation may be from about 0.05 MHz to about 150 MHz (e.g., from about 0.1 MHz to about 150 MHz, about 0.5 MHz to about 150 MHz, about 1 MHz to about 150 MHz, about 5 MHz to about 150 MHz, about 10 MHz to about 150 MHz, about 50 MHz to about 150 MHz, about 100 MHz to about 150 MHz, about 0.05 MHz to about 100 MHz, about 0.05 MHz to about 50 MHz, about 0.05 MHz to about 10 MHz, about 0.05 MHz to about 1 MHz, about 0.05 MHz to about 0.1 MHz, about 0.1 MHz to about 100 MHz, about 1 MHz to about 50 MHz, about 5 MHz to about 50 MHz, about 10 MHz to about 20 MHz).

In some embodiments, the second liquid is added while the plate is moving. The rate of adding second liquid may be from about 150 μL/min to about 115 L/min (e.g., from about 250 μL/min to about 115 L/min, about 500 μL/min to about 115 L/min, about 750 μL/min to about 115 L/min, about 1000 μL/min to about 115 L/min, about 5 mL/min to about 115 L/min, about 10 mL/min to about 115 L/min, about 50 mL/min to about 115 L/min, about 100 mL/min to about 115 L/min, about 250 mL/min to about 115 L/min, about 500 mL/min to about 115 L/min, about 1 L/min to about 115 L/min, about 5 L/min to about 115 L/min, about 10 L/min to about 115 L/min, about 50 L/min to about 115 L/min, about 100 L/min to about 115 L/min, about 150 μL/min to about 100 L/min, about 150 μL/min to about 50 L/min, about 150 μL/min to about 10 L/min, about 150 μL/min to about 1 L/min, about 150 μL/min to about 500 mL/min, about 150 μL/min to about 100 mL/min, about 150 μL/min to about 1 mL/min, about 150 μL/min to about 500 μL/min, about 150 μL/min to about 250 μL/min, about 250 μL/min to about 100 L/min, about 500 μL/min to about 50 L/min, about 1000 μL/min to about 1 L/min, about 5 mL/min to about 500 mL/min, about 100 mL/min to about 250 mL/min).

In some embodiments, the plate includes a reservoir containing second liquid. In some embodiments, the first liquid is less dense than the second liquid. In some embodiments, the first liquid includes particles. The particles may be beads (e.g., gel beads) or biological particles (e.g., cells or nuclei).

In another aspect, the invention features a method of collecting droplets by (a) providing a reservoir including a second liquid that partially fills the reservoir; and (b) allowing droplets of a first liquid to contact the second liquid as the second liquid is moved, e.g., rotated, wherein the droplets are transported from the point of contact, e.g., radially outwardly, and the first and second liquids are immiscible with each other.

In some embodiments, the reservoir is rotated. The rate of rotation of the reservoir may be from about 0.05 MHz to about 150 MHz (e.g., from about 0.1 MHz to about 150 MHz, about 0.5 MHz to about 150 MHz, about 1 MHz to about 150 MHz, about 5 MHz to about 150 MHz, about 10 MHz to about 150 MHz, about 50 MHz to about 150 MHz, about 100 MHz to about 150 MHz, about 0.05 MHz to about 100 MHz, about 0.05 MHz to about 50 MHz, about 0.05 MHz to about 10 MHz, about 0.05 MHz to about 1 MHz, about 0.05 MHz to about 0.1 MHz, about 0.1 MHz to about 100 MHz, about 1 MHz to about 50 MHz, about 5 MHz to about 50 MHz, about 10 MHz to about 20 MHz). In some embodiments, the motion of the plate in step (a) is oscillatory. The frequency of oscillation may be from about 0.05 MHz to about 150 MHz (e.g., from about 0.1 MHz to about 150 MHz, about 0.5 MHz to about 150 MHz, about 1 MHz to about 150 MHz, about 5 MHz to about 150 MHz, about 10 MHz to about 150 MHz, about 50 MHz to about 150 MHz, about 100 MHz to about 150 MHz, about 0.05 MHz to about 100 MHz, about 0.05 MHz to about 50 MHz, about 0.05 MHz to about 10 MHz, about 0.05 MHz to about 1 MHz, about 0.05 MHz to about 0.1 MHz, about 0.1 MHz to about 100 MHz, about 1 MHz to about 50 MHz, about 5 MHz to about 50 MHz, about 10 MHz to about 20 MHz).

In some embodiments, the reservoir includes an inlet and an outlet, and the second liquid flows from the inlet to the outlet. The flow rate of the second liquid may be from about 150 μL/min to about 115 L/min (e.g., from about 250 μL/min to about 115 L/min, about 500 μL/min to about 115 L/min, about 750 μL/min to about 115 L/min, about 1000 μL/min to about 115 L/min, about 5 mL/min to about 115 L/min, about 10 mL/min to about 115 L/min, about 50 mL/min to about 115 L/min, about 100 mL/min to about 115 L/min, about 250 mL/min to about 115 L/min, about 500 mL/min to about 115 L/min, about 1 L/min to about 115 L/min, about 5 L/min to about 115 L/min, about 10 L/min to about 115 L/min, about 50 L/min to about 115 L/min, about 100 L/min to about 115 L/min, about 150 μL/min to about 100 L/min, about 150 μL/min to about 50 L/min, about 150 μL/min to about 10 L/min, about 150 μL/min to about 1 L/min, about 150 μL/min to about 500 mL/min, about 150 μL/min to about 100 mL/min, about 150 μL/min to about 1 mL/min, about 150 μL/min to about 500 μL/min, about 150 μL/min to about 250 μL/min, about 250 μL/min to about 100 L/min, about 500 μL/min to about 50 L/min, about 1000 μL/min to about 1 L/min, about 5 mL/min to about 500 mL/min, about 100 mL/min to about 250 mL/min).

In some embodiments, the first liquid is less dense than the second liquid. In some embodiments, the first liquid includes particles. The particles may be beads (e.g., gel beads) or biological particles (e.g., cells or nuclei).

In some embodiments, the reservoir includes a cone-shaped trough. In some embodiments, the second liquid is rotated into a vortex.

In another aspect, the invention features a device including a first channel having a first proximal end and a first distal end, wherein the first distal end is open to the exterior of the device; and a non-intersecting channel having a proximal end and a distal end, wherein the non-intersecting channel does not intersect the first channel, and the distal end of the non-intersecting channel is open to the exterior of the device and positioned to allow liquid passing there through, e.g., second liquid, to contact droplets formed at the distal end of the first channel. The invention further features systems of this device in combination with a collection reservoir and methods of forming droplets therewith.

In embodiments of any the devices, systems, and methods described herein, the exterior of the device around an outlet (or distal end) includes a material that the fluid exiting the outlet does not wet. For channels including aqueous or hydrophilic liquids, the material around the outlet may be hydrophobic. For channels including hydrophobic or fluorophilic liquids, the material around the outlet may be hydrophilic or fluorophobic.

In another aspect, the invention features a method of producing droplets by providing a device having a first channel with an outlet, transporting a liquid through the outlet, and pulsing electromagnetic energy to evaporate a portion of the liquid to produce droplets.

In some embodiments, the electromagnetic energy originates from a source including a laser, a light-emitting diode (LED), or a broadband light source. In some embodiments the source of electromagnetic energy has an output wavelength from about 100 nm to about 1 mm (e.g., from about 100 nm to about 1,000 nm, e.g., about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1000 nm), or (e.g., from about 1,000 nm to about 10,000 nm, e.g., about 1,050 nm, about 1,100 nm, about 1,150 nm, about 1,200 nm, about 1,250 nm, about 1,300 nm, about 1,350 nm, about 1,400 nm, about 1,450 nm, about 1,500 nm, about 1,550 nm, about 1,600 nm, about 1,650 nm, about 1,700 nm, about 1,750 nm, about 1,800 nm, about 1,850 nm, about 1,900 nm, about 2,000 nm, about 3,000 nm, about 4,000 nm, about 5,000 nm, about 6,000 nm, about 7,000 nm, about 8,000 nm, about 9,000 nm, or about 10,000 nm), or (e.g., from about 10,000 nm to about 100,000 nm, e.g., about 20,000 nm, about 30,000 nm, about 40,000 nm, about 50,000 nm, about 60,000 nm, about 70,000 nm, about 80,000 nm, about 90,000 nm, or about 100,000 nm), or (e.g., from about 100,000 nm to about 1,000,000 nm, e.g., about 200,000 nm, about 300,000 nm, about 400,000 nm, about 500,000 nm, about 600,000 nm, about 700,000 nm, about 800,000 nm, about 900,000 nm, or about 1,000,000 nm).

In some embodiments, the source of electromagnetic energy has an output power density from about 1 W/mm² to about 1,000 W/mm² (e.g., from about 1 W/mm² to about 10 W/mm², e.g., about 1.5 W/mm², about 2.0 W/mm², about 2.5 W/mm², about 3.0 W/mm², about 3.5 W/mm², about 4.0 W/mm², about 4.5 W/mm², about 5.0 W/mm², about 5.5 W/mm², about 6.0 W/mm², about 6.5 W/mm², about 7.0 W/mm², about 7.5 W/mm², about 8.0 W/mm², about 8.5 W/mm², about 9.0 W/mm², about 9.5 W/mm², or about 10.0 W/mm²), or (e.g., from about 10 W/mm² to about 100 W/mm², e.g., about 15 W/mm², about 20 W/mm², about 25 W/mm², about 30 W/mm², about 35 W/mm², about 40 W/mm², about 45 W/mm², about 50 W/mm², about 55 W/mm², about 60 W/mm², about 65 W/mm², about 70 W/mm², about 75 W/mm², about 80 W/mm², about 85 W/mm², about 90 W/mm², about 95 W/mm², or about 100 W/mm²), or (e.g., from about 100 W/mm² to about 1,000 W/mm², e.g., about 150 W/mm², about 200 W/mm², about 250 W/mm², about 300 W/mm², about 350 W/mm², about 400 W/mm², about 450 W/mm², about 500 W/mm², about 550 W/mm², about 600 W/mm², about 650 W/mm², about 700 W/mm², about 750 W/mm², about 800 W/mm², about 850 W/mm², about 900 W/mm², about 950 W/mm², or about 1,000 W/mm²).

In some embodiments, the source of electromagnetic energy has an output pulse frequency from about 0.1 Hz to about 1,000,000 Hz (e.g., from about 0.1 Hz to about 1.0 Hz, e.g., about 0.2 Hz, about 0.3 Hz, about 0.4 Hz, about 0.5 Hz, about 0.6 Hz, about 0.7 Hz, about 0.8 Hz, about 0.9 Hz, or about 1.0 Hz), or (e.g., from about 1.0 Hz to about 10 Hz, e.g., about 1.5 Hz, about 2.0 Hz, about 2.5 Hz, about 3.0 Hz, about 3.5 Hz, about 4.0 Hz, about 4.5 Hz, about 5.0 Hz, about 5.5 Hz, about 6.0 Hz, about 6.5 Hz, about 7.0 Hz, about 7.5 Hz, about 8.0 Hz, about 8.5 Hz, about 9.0 Hz, about 9.5 Hz, or about 10 Hz), or (e.g., from about 10 Hz to about 100 Hz, e.g., about 15 Hz, about 20 Hz, about 25 Hz, about 30 Hz, about 35 Hz, about 40 Hz, about 45 Hz, about 50 Hz, about 55 Hz, about 60 Hz, about 65 Hz, about 70 Hz, about 75 Hz, about 80 Hz, about 85 Hz, about 90 Hz, about 95 Hz, or about 100 Hz), or (e.g., from about 100 Hz to about 1,000 Hz, e.g., about 150 Hz, about 200 Hz, about 250 Hz, about 300 Hz, about 350 Hz, about 400 Hz, about 450 Hz, about 500 Hz, about 550 Hz, about 600 Hz, about 650 Hz, about 700 Hz, about 750 Hz, about 800 Hz, about 850 Hz, about 900 Hz, about 950 Hz, or about 1,000 Hz), or (e.g., from about 1,000 Hz to about 10,000 Hz, e.g., about 1,500 Hz, about 2,000 Hz, about 2,500 Hz, about 3,000 Hz, about 3,500 Hz, about 4,000 Hz, about 4,500 Hz, about 5,000 Hz, about 5,500 Hz, about 6,000 Hz, about 6,500 Hz, about 7,000 Hz, about 7,500 Hz, about 8,000 Hz, about 8,500 Hz, about 9,000 Hz, about 9,500 Hz, or about 10,000 Hz), (e.g., from about 10,000 Hz to about 100,000 Hz, e.g., about 15,000 Hz, about 20,000 Hz, about 25,000 Hz, about 30,000 Hz, about 35,000 Hz, about 40,000 Hz, about 45,000 Hz, about 50,000 Hz, about 55,000 Hz, about 60,000 Hz, about 65,000 Hz, about 70,000 Hz, about 75,000 Hz, about 80,000 Hz, about 85,000 Hz, about 90,000 Hz, about 95,000 Hz, or about 100,000 Hz), or (e.g., from about 100,000 Hz to about 1,000,000 Hz, e.g., about 150,000 Hz, about 200,000 Hz, about 250,000 Hz, about 300,000 Hz, about 350,000 Hz, about 400,000 Hz, about 450,000 Hz, about 500,000 Hz, about 550,000 Hz, about 600,000 Hz, about 650,000 Hz, about 700,000 Hz, about 750,000 Hz, about 800,000 Hz, about 850,000 Hz, about 900,000 Hz, about 950,000 Hz, or about 1,000,000 Hz).

In some embodiments, the droplets are produced at a rate of at least 10 (e.g., at least about 20, about 30, about 40, about 50, about 60, about 70, about 80, about 90, about 100, or more) droplets per second. In further embodiments, the device includes a plurality of first channels, each having an outlet, and the method includes transporting a liquid through the outlet of each of the plurality of first channels. In some embodiments, the plurality of first channels includes 2, 3, 4, 5, 6, 7, 8, 9, or 10 first channels.

In some embodiments, the liquid includes an electromagnetic energy-absorbing material. In some embodiments, the electromagnetic energy-absorbing material generates heat by absorbing electromagnetic energy.

In further embodiments, the device includes a cladding around the first channel to direct the electromagnetic energy to the outlet.

In another aspect, the invention provides a method of decreasing the size of droplets by providing droplets having a flow velocity, synchronizing a source of electromagnetic energy to the flow velocity, and pulsing electromagnetic energy from the source to evaporate at least a portion of the droplets, thereby reducing the size of the droplets.

In some embodiments, the droplets are generated using the methods described herein. In some embodiments, the flow velocity is from about 0.01 m/s to about 10 m/s (e.g., from about 0.01 m/s to about 0.1 m/s, e.g., about 0.02 m/s, about 0.03 m/s, about 0.04 m/s, about 0.05 m/s, about 0.06 m/s, about 0.07 m/s, about 0.08 m/s, about 0.09 m/s, or about 0.1 m/s), or (e.g., from about 0.1 m/s to about 1.0 m/s, e.g., about 0.2 m/s, about 0.3 m/s, about 0.4 m/s, about 0.5 m/s, about 0.6 m/s, about 0.7 m/s, about 0.8 m/s, about 0.9 m/s, or 1 about 0 m/s), or (e.g., from about 1.0 m/s to about 10.0 m/s, e.g., about 1.5 m/s, about 2.0 m/s, about 2.5 m/s, about 3.0 m/s, about 3.5 m/s, about 4.0 m/s, about 4.5 m/s, about 5.0 m/s, about 5.5 m/s, about 6.0 m/s, about 6.5 m/s, about 7.0 m/s, about 7.5 m/s, about 8.0 m/s, about 8.5 m/s, about 9.0 m/s, about 9.5 m/s, or about 10.0 m/s).

In some embodiments, the source of electromagnetic energy includes a laser, a light-emitting diode (LED), or a broadband light source. In some embodiments, the source of electromagnetic energy has an output wavelength from about 100 nm to about 1,000,000 nm (e.g., from about 100 nm to about 1,000 nm, e.g., about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1000 nm), or (e.g., from about 1,000 nm to about 10,000 nm, e.g., about 1,050 nm, about 1,100 nm, about 1,150 nm, about 1,200 nm, about 1,250 nm, about 1,300 nm, about 1,350 nm, about 1,400 nm, about 1,450 nm, about 1,500 nm, about 1,550 nm, about 1,600 nm, about 1,650 nm, about 1,700 nm, about 1,750 nm, about 1,800 nm, about 1,850 nm, about 1,900 nm, about 2,000 nm, about 3,000 nm, about 4,000 nm, about 5,000 nm, about 6,000 nm, about 7,000 nm, about 8,000 nm, about 9,000 nm, or about 10,000 nm), or (e.g., from about 10,000 nm to about 100,000 nm, e.g., about 20,000 nm, about 30,000 nm, about 40,000 nm, about 50,000 nm, about 60,000 nm, about 70,000 nm, about 80,000 nm, about 90,000 nm, or about 100,000 nm), or (e.g., from about 100,000 nm to about 1,000,000 nm, e.g., about 200,000 nm, about 300,000 nm, about 400,000 nm, about 500,000 nm, about 600,000 nm, about 700,000 nm, about 800,000 nm, about 900,000 nm, or about 1,000,000 nm).

In some embodiments, the source of electromagnetic energy has an output power density from about 1 W/mm² to about 1,000 W/mm² (e.g., from about 1 W/mm² to about 10 W/mm², e.g., about 1.5 W/mm², about 2.0 W/mm², about 2.5 W/mm², about 3.0 W/mm², about 3.5 W/mm², about 4.0 W/mm², about 4.5 W/mm², about 5.0 W/mm², about 5.5 W/mm², about 6.0 W/mm², about 6.5 W/mm², about 7.0 W/mm², about 7.5 W/mm², about 8.0 W/mm², about 8.5 W/mm², about 9.0 W/mm², about 9.5 W/mm², or about 10.0 W/mm²), or (e.g., from about 10 W/mm² to about 100 W/mm², e.g., about 15 W/mm², about 20 W/mm², about 25 W/mm², about 30 W/mm², about 35 W/mm², about 40 W/mm², about 45 W/mm², about 50 W/mm², about 55 W/mm², about 60 W/mm², about 65 W/mm², about 70 W/mm², about 75 W/mm², about 80 W/mm², about 85 W/mm², about 90 W/mm², about 95 W/mm², or about 100 W/mm²), or (e.g., from about 100 W/mm² to about 1,000 W/mm², e.g., about 150 W/mm², about 200 W/mm², about 250 W/mm², about 300 W/mm², about 350 W/mm², about 400 W/mm², about 450 W/mm², about 500 W/mm², about 550 W/mm², about 600 W/mm², about 650 W/mm², about 700 W/mm², about 750 W/mm², about 800 W/mm², about 850 W/mm², about 900 W/mm², about 950 W/mm², or about 1,000 W/mm²).

In some embodiments, the source of electromagnetic energy has an output pulse frequency from about 0.1 Hz to about 1,000,000 Hz (e.g., from about 0.1 Hz to about 1.0 Hz, e.g., about 0.2 Hz, about 0.3 Hz, about 0.4 Hz, about 0.5 Hz, about 0.6 Hz, about 0.7 Hz, about 0.8 Hz, about 0.9 Hz, or about 1.0 Hz), or (e.g., from about 1.0 Hz to about 10 Hz, e.g., about 1.5 Hz, about 2.0 Hz, about 2.5 Hz, about 3.0 Hz, about 3.5 Hz, about 4.0 Hz, about 4.5 Hz, about 5.0 Hz, about 5.5 Hz, about 6.0 Hz, about 6.5 Hz, about 7.0 Hz, about 7.5 Hz, about 8.0 Hz, about 8.5 Hz, about 9.0 Hz, about 9.5 Hz, or about 10 Hz), or (e.g., from about 10 Hz to about 100 Hz, e.g., about 15 Hz, about 20 Hz, about 25 Hz, about 30 Hz, about 35 Hz, about 40 Hz, about 45 Hz, about 50 Hz, about 55 Hz, about 60 Hz, about 65 Hz, about 70 Hz, about 75 Hz, about 80 Hz, about 85 Hz, about 90 Hz, about 95 Hz, or about 100 Hz), or (e.g., from about 100 Hz to about 1,000 Hz, e.g., about 150 Hz, about 200 Hz, about 250 Hz, about 300 Hz, about 350 Hz, about 400 Hz, about 450 Hz, about 500 Hz, about 550 Hz, about 600 Hz, about 650 Hz, about 700 Hz, about 750 Hz, about 800 Hz, about 850 Hz, about 900 Hz, about 950 Hz, or about 1,000 Hz), or (e.g., from about 1,000 Hz to about 10,000 Hz, e.g., about 1,500 Hz, about 2,000 Hz, about 2,500 Hz, about 3,000 Hz, about 3,500 Hz, about 4,000 Hz, about 4,500 Hz, about 5,000 Hz, about 5,500 Hz, about 6,000 Hz, about 6,500 Hz, about 7,000 Hz, about 7,500 Hz, about 8,000 Hz, about 8,500 Hz, about 9,000 Hz, about 9,500 Hz, or about 10,000 Hz), (e.g., from about 10,000 Hz to about 100,000 Hz, e.g., about 15,000 Hz, about 20,000 Hz, about 25,000 Hz, about 30,000 Hz, about 35,000 Hz, about 40,000 Hz, about 45,000 Hz, about 50,000 Hz, about 55,000 Hz, about 60,000 Hz, about 65,000 Hz, about 70,000 Hz, about 75,000 Hz, about 80,000 Hz, about 85,000 Hz, about 90,000 Hz, about 95,000 Hz, or about 100,000 Hz), or (e.g., from about 100,000 Hz to about 1,000,000 Hz, e.g., about 150,000 Hz, about 200,000 Hz, about 250,000 Hz, about 300,000 Hz, about 350,000 Hz, about 400,000 Hz, about 450,000 Hz, about 500,000 Hz, about 550,000 Hz, about 600,000 Hz, about 650,000 Hz, about 700,000 Hz, about 750,000 Hz, about 800,000 Hz, about 850,000 Hz, about 900,000 Hz, about 950,000 Hz, or about 1,000,000 Hz).

In some embodiments, the droplets include an electromagnetic energy-absorbing material.

In some embodiments, the electromagnetic energy-absorbing material generates heat by absorbing electromagnetic energy.

In some embodiments, the droplets include a solvent and a solute, and decreasing the size of the droplets leads to an increase in the concentration of the solute. In some embodiments, the method described herein further includes identifying a droplet to be removed. In some embodiments, the liquid in the droplet is substantially evaporated.

In another aspect, the invention provides a system for producing droplets or decreasing the size of droplets. The system includes a device including a first channel having an inlet and an outlet and a source of electromagnetic energy disposed to illuminate liquid or droplets exiting the outlet.

In some embodiments, the source of electromagnetic energy is disposed to pulse electromagnetic energy onto liquid transported through the outlet to produce droplets of the liquid. In some embodiments, the device further includes a cladding around the first channel to direct the electromagnetic energy to the outlet.

In some embodiments, the source of electromagnetic energy includes a laser, a light-emitting diode (LED), or a broadband light source. In some embodiments, the source of electromagnetic energy has an output wavelength from about 100 nm to about 1,000,000 nm (e.g., from about 100 nm to about 1,000 nm, e.g., about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1000 nm), or (e.g., from about 1,000 nm to about 10,000 nm, e.g., about 1,050 nm, about 1,100 nm, about 1,150 nm, about 1,200 nm, about 1,250 nm, about 1,300 nm, about 1,350 nm, about 1,400 nm, about 1,450 nm, about 1,500 nm, about 1,550 nm, about 1,600 nm, about 1,650 nm, about 1,700 nm, about 1,750 nm, about 1,800 nm, about 1,850 nm, about 1,900 nm, about 2,000 nm, about 3,000 nm, about 4,000 nm, about 5,000 nm, about 6,000 nm, about 7,000 nm, about 8,000 nm, about 9,000 nm, or about 10,000 nm), or (e.g., from about 10,000 nm to about 100,000 nm, e.g., about 20,000 nm, about 30,000 nm, about 40,000 nm, about 50,000 nm, about 60,000 nm, about 70,000 nm, about 80,000 nm, about 90,000 nm, or about 100,000 nm), or (e.g., from about 100,000 nm to about 1,000,000 nm, e.g., about 200,000 nm, about 300,000 nm, about 400,000 nm, about 500,000 nm, about 600,000 nm, about 700,000 nm, about 800,000 nm, about 900,000 nm, or about 1,000,000 nm).

In some embodiments, the source of electromagnetic energy has an output power density from about 1 W/mm² to about 1,000 W/mm² (e.g., from about 1 W/mm² to about 10 W/mm², e.g., about 1.5 W/mm², about 2.0 W/mm², about 2.5 W/mm², about 3.0 W/mm², about 3.5 W/mm², about 4.0 W/mm², about 4.5 W/mm², about 5.0 W/mm², about 5.5 W/mm², about 6.0 W/mm², about 6.5 W/mm², about 7.0 W/mm², about 7.5 W/mm², about 8.0 W/mm², about 8.5 W/mm², about 9.0 W/mm², about 9.5 W/mm², about 10.0 W/mm²), or (e.g., from about 10 W/mm² to about 100 W/mm², e.g., about 15 W/mm², about 20 W/mm², about 25 W/mm², about 30 W/mm², about 35 W/mm², about 40 W/mm², about 45 W/mm², about 50 W/mm², about 55 W/mm², about 60 W/mm², about 65 W/mm², about 70 W/mm², about 75 W/mm², about 80 W/mm², about 85 W/mm², about 90 W/mm², about 95 W/mm², or about 100 W/mm²), or (e.g., from about 100 W/mm² to about 1,000 W/mm², e.g., about 150 W/mm², about 200 W/mm², about 250 W/mm², about 300 W/mm², about 350 W/mm², about 400 W/mm², about 450 W/mm², about 500 W/mm², about 550 W/mm², about 600 W/mm², about 650 W/mm², about 700 W/mm², about 750 W/mm², about 800 W/mm², about 850 W/mm², about 900 W/mm², about 950 W/mm², or about 1,000 W/mm²).

In some embodiments, the source of electromagnetic energy has an output pulse frequency from about 0.1 Hz to about 1,000,000 Hz (e.g., from about 0.1 Hz to about 1.0 Hz, e.g., about 0.2 Hz, about 0.3 Hz, about 0.4 Hz, about 0.5 Hz, about 0.6 Hz, about 0.7 Hz, about 0.8 Hz, about 0.9 Hz, or about 1.0 Hz), or (e.g., from about 1.0 Hz to about 10 Hz, e.g., about 1.5 Hz, about 2.0 Hz, about 2.5 Hz, about 3.0 Hz, about 3.5 Hz, about 4.0 Hz, about 4.5 Hz, about 5.0 Hz, about 5.5 Hz, about 6.0 Hz, about 6.5 Hz, about 7.0 Hz, about 7.5 Hz, about 8.0 Hz, about 8.5 Hz, about 9.0 Hz, about 9.5 Hz, or about 10 Hz), or (e.g., from about 10 Hz to about 100 Hz, e.g., about 15 Hz, about 20 Hz, about 25 Hz, about 30 Hz, about 35 Hz, about 40 Hz, about 45 Hz, about 50 Hz, about 55 Hz, about 60 Hz, about 65 Hz, about 70 Hz, about 75 Hz, about 80 Hz, about 85 Hz, about 90 Hz, about 95 Hz, or about 100 Hz), or (e.g., from about 100 Hz to about 1,000 Hz, e.g., about 150 Hz, about 200 Hz, about 250 Hz, about 300 Hz, about 350 Hz, about 400 Hz, about 450 Hz, about 500 Hz, about 550 Hz, about 600 Hz, about 650 Hz, about 700 Hz, about 750 Hz, about 800 Hz, about 850 Hz, about 900 Hz, about 950 Hz, or about 1,000 Hz), or (e.g., from about 1,000 Hz to about 10,000 Hz, e.g., about 1,500 Hz, about 2,000 Hz, about 2,500 Hz, about 3,000 Hz, about 3,500 Hz, about 4,000 Hz, about 4,500 Hz, about 5,000 Hz, about 5,500 Hz, about 6,000 Hz, about 6,500 Hz, about 7,000 Hz, about 7,500 Hz, about 8,000 Hz, about 8,500 Hz, about 9,000 Hz, about 9,500 Hz, or about 10,000 Hz), (e.g., from about 10,000 Hz to about 100,000 Hz, e.g., about 15,000 Hz, about 20,000 Hz, about 25,000 Hz, about 30,000 Hz, about 35,000 Hz, about 40,000 Hz, about 45,000 Hz, about 50,000 Hz, about 55,000 Hz, about 60,000 Hz, about 65,000 Hz, about 70,000 Hz, about 75,000 Hz, about 80,000 Hz, about 85,000 Hz, about 90,000 Hz, about 95,000 Hz, or about 100,000 Hz), or (e.g., from about 100,000 Hz to about 1,000,000 Hz, e.g., about 150,000 Hz, about 200,000 Hz, about 250,000 Hz, about 300,000 Hz, about 350,000 Hz, about 400,000 Hz, about 450,000 Hz, about 500,000 Hz, about 550,000 Hz, about 600,000 Hz, about 650,000 Hz, about 700,000 Hz, about 750,000 Hz, about 800,000 Hz, about 850,000 Hz, about 900,000 Hz, about 950,000 Hz, or about 1,000,000 Hz).

In some embodiments, the system further includes a detector disposed to detect droplets. In further embodiments, the source of electromagnetic energy is disposed to pulse electromagnetic energy to decrease the size of droplets.

### Definitions

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

The terms “adaptor(s),” “adapter(s),” and “tag(s)” may be used synonymously. An adaptor or tag can be coupled to a polynucleotide sequence to be “tagged” by any approach including ligation, hybridization, or other approaches.

The term “barcode,” as used herein, generally refers to a label, or identifier, that conveys or is capable of conveying information about an analyte. A barcode can be part of an analyte. A barcode can be a tag attached to an analyte (e.g., nucleic acid molecule) or a combination of the tag in addition to an endogenous characteristic of the analyte (e.g., size of the analyte or end sequence(s)). A barcode may be unique. Barcodes can have a variety of different formats. For example, barcodes can include polynucleotide barcodes; random nucleic acid and/or amino acid sequences; and synthetic nucleic acid and/or amino acid sequences. A barcode can be attached to an analyte in a reversible or irreversible manner. A barcode can be added to, for example, a fragment of a deoxyribonucleic acid (DNA) or ribonucleic acid (RNA) sample before, during, and/or after sequencing of the sample. Barcodes can allow for identification and/or quantification of individual sequencing-reads in real time.

The term “bead,” as used herein, generally refers to a particle that is not a biological particle. The bead may be a solid or semi-solid particle. The bead may be a gel bead. The gel bead may include a polymer matrix (e.g., matrix formed by polymerization or cross-linking). The polymer matrix may include one or more polymers (e.g., polymers having different functional groups or repeat units). Polymers in the polymer matrix may be randomly arranged, such as in random copolymers, and/or have ordered structures, such as in block copolymers. Cross-linking can be via covalent, ionic, or inductive, interactions, or physical entanglement. The bead may be a macromolecule. The bead may be formed of nucleic acid molecules bound together. The bead may be formed via covalent or non-covalent assembly of molecules (e.g., macromolecules), such as monomers or polymers. Such polymers or monomers may be natural or synthetic. Such polymers or monomers may be or include, for example, nucleic acid molecules (e.g., DNA or RNA). The bead may be formed of a polymeric material. The bead may be magnetic or non-magnetic. The bead may be rigid. The bead may be flexible and/or compressible. The bead may be disruptable or dissolvable. The bead may be a solid particle (e.g., a metal-based particle including but not limited to iron oxide, gold or silver) covered with a coating comprising one or more polymers. Such coating may be disruptable or dissolvable.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) comprising a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or another organelle of a cell. A cell may be a live cell. The live cell may be capable of being cultured, for example, being cultured when enclosed in a gel or polymer matrix or cultured when comprising a gel or polymer matrix.

The term “broadband,” as used herein, refers to a light source which emits light having a broad range of wavelengths, such as for example, spanning 50 nm or more, such as 100 nm or more, such as 150 nm or more, such as 200 nm or more, such as 250 nm or more, such as 300 nm or more, such as 350 nm or more, such as 400 nm or more and including spanning 500 nm or more. For example, one suitable broadband light source emits light having wavelengths from 400 nm to 700 nm. Another example of a suitable broadband light source includes a light source that emits light having wavelengths from 500 nm to 700 nm. Examples include a halogen lamp, deuterium arc lamp, xenon arc lamp, stabilized fiber-coupled broadband light source, a broadband LED with continuous spectrum, superluminescent emitting diode, semiconductor light emitting diode, wide spectrum LED white light source, and a multi-LED integrated white light source.

The term “cladding,” as used herein, refers to one or more layers of an optical material surrounding a channel that is designed to confine and direct the propagation of light.

The term “does not wet,” as used herein refers to a degree of wettability where the liquid has a contact angle of 70° or greater, e.g., at least 90°, with the material. The measurement of the contact angle need not occur in a device or system of the invention but instead can occur using the same material and liquid in a separate assay.

The term “fluidically connected,” as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can comprise coding regions that code for proteins as well as non-coding regions. A genome can include the sequence of all chromosomes together in an organism. For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may comprise a nucleic acid. In some cases, the biological particle may be a macromolecule. The macromolecular constituent may comprise DNA or a DNA molecule. The macromolecular constituent may comprise RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may comprise a protein. The macromolecular constituent may comprise a peptide. The macromolecular constituent may comprise a polypeptide or a protein. The polypeptide or protein may be an extracellular or an intracellular polypeptide or protein. The macromolecular constituent may also comprise a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529 each of which is incorporated herein by reference in its entirety).

The term “molecular tag,” as used herein, generally refers to a molecule capable of binding to a macromolecular constituent. The molecular tag may bind to the macromolecular constituent with high affinity. The molecular tag may bind to the macromolecular constituent with high specificity. The molecular tag may comprise a nucleotide sequence. The molecular tag may comprise an oligonucleotide or polypeptide sequence. The molecular tag may comprise a DNA aptamer. The molecular tag may be or comprise a primer. The molecular tag may be or comprise a protein. The molecular tag may comprise a polypeptide. The molecular tag may be a barcode.

The term “non-biological particle,” as used herein, refers to a particle that is not a biological particle, as described herein.

The term “oil,” as used herein, generally refers to a liquid that is not miscible with water. An oil may have a density higher or lower than water and/or a viscosity higher or lower than water.

The term “sample,” as used herein, generally refers to a biological sample of a subject. The biological sample may be a nucleic acid sample or protein sample. The biological sample may be derived from another sample. The sample may be a tissue sample, such as a biopsy, core biopsy, needle aspirate, or fine needle aspirate. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “substantially constant,” as used herein with respect to a vertical location of the shunt, generally refers to a state when a distance from the shunt to the interface is within ±10% of the average level.

The term “substantially stationary,” as used herein with respect to droplet formation, generally refers to a state when motion of formed droplets in the continuous phase is passive, e.g., resulting from the difference in density between the dispersed phase and the continuous phase.

### BRIEF DESCRIPTION OF THE DRAWINGS

FIG. 1 is a scheme of a microfluidic device including a channel operatively coupled to an actuator and a reservoir positioned below the device. The outlet of the device crosses the interface of the liquid in the reservoir and a second fluid (e.g., air).

FIG. 2 is a scheme showing a time course of droplet formation with a device as described herein.

FIG. 3 is a scheme showing a system described herein. The system includes a device, a reservoir positioned below the device, and two syringe pumps. The device is attached to an actuator placed on a moving platform. The system also includes a liquid level sensor to determine the level of the liquid in the reservoir.

FIG. 4 is a scheme showing a device in which the interface in the reservoir is between two immiscible liquids.

FIG. 5 is a scheme showing a device in which two liquids are mixed upstream of the outlet, thereby allowing a longer mixing time.

FIG. 6 is a scheme showing a device in which the phases are switched. The device contains oil, and the reservoir contains the aqueous phases.

FIG. 7 is a scheme showing a device in which the droplet is less dense than the continuous phase, and the droplets rise after they are generated.

FIG. 8 is a scheme showing a device in which the reservoir moves while the device remains stationary.

FIG. 9 is a scheme showing a device with an actuator, such as an ultrasonic transducer, that vibrates the interface of the liquid in the reservoir while the device and the reservoir remain stationary.

FIG. 10 is a scheme showing device in which the reservoir contains a shunt, which maintains a constant vertical location of the interface as droplets are formed.

FIG. 11 is a scheme showing a microfluidic device with a plurality of channels. Each channel contains an outlet to form droplets from each channel simultaneously. The inset on the right shows an optional feature in which the chip includes a nozzle at the opening of the channel.

FIG. 12A is a scheme showing an embodiment of a system in which a microfluidic device produces droplets over a trough. A second fluid (in this case an oil) flows from the inlet to the outlet. The flowing oil moves the droplets away from the point of contact.

FIG. 12B is a series of micrographs showing the results of droplet formation without and with using a trough. FIG. 12B highlights the superior uniformity of the droplet size by using a trough.

FIG. 13 is a scheme showing an embodiment of a system in which a microfluidic device produces droplets over a plate. The plate, and the fluid on top of it, rotate to move the incoming droplets away from the point of contact.

FIG. 14A is a scheme showing an embodiment of a system in which a microfluidic device produces droplets over a reservoir. The fluid in the reservoir is rotated to move the incoming droplets away from the point of contact.

FIG. 14B is a scheme showing an embodiment of a system in which a microfluidic device produces droplets over a cone shaped reservoir. The fluid in the reservoir rotates as it travels from an inlet to an outlet and moves the incoming droplets away from the point of contact.

FIG. 15A is a scheme showing an embodiment of a system in which a microfluidic device is connected to two reservoirs and equipped with a piezoelectric element to vibrate the device. The droplets are formed as liquid exits the device and fall into a third reservoir with a liquid in which the droplets are immiscible.

FIG. 15B is a scheme showing an embodiment of a system in which a microfluidic device is connected to two reservoirs and equipped with a piezoelectric element to vibrate the device. The droplets are formed as liquid exits the device into a third reservoir with a liquid in which the droplets are immiscible. In this embodiment, the exit of the device is submerged in the immiscible liquid.

FIG. 15C is a series of photographs of devices of FIG. 15A and FIG. 15B producing droplets in air and directly in the immiscible fluid.

FIG. 16 is a scheme showing an embodiment of the invention illustrating a method of producing droplets containing a single bead.

FIG. 17 is a scheme showing an embodiment of a system in which a microfluidic device is connected to three reservoirs and equipped with a piezoelectric element to vibrate the device. The microfluidic device combines two liquids that form droplets. As the droplets are formed, they are coated with a liquid in which they are immiscible. The droplets are then allowed to fall into a reservoir.

FIG. 18 is a scheme showing a channel having an outlet and a liquid flowing within the channel towards the outlet and exiting the outlet. A light source is activated and illuminates a portion of the liquid exiting the outlet.

FIG. 19 is a scheme showing a channel having an outlet and a liquid flowing within the channel towards the outlet and exiting the outlet. A light source is activated and modulated according to a pulse pattern to illuminate a portion of the liquid exiting the outlet. The pulsed light directed at the liquid exiting the channel creates localized heating that causes evaporation of the liquid and generates droplets.

FIG. 20 is a scheme showing a channel having an outlet and a liquid flowing within the channel towards the outlet and exiting the outlet. The channel is surrounded by a cladding that accepts light at a location upstream of the outlet, confines the light, and directs the propagation of light to a portion of the liquid exiting the outlet. Illumination of the liquid exiting the outlet causes localized heating, evaporation, and the generation of a droplet.

FIG. 21 is a scheme showing the reduction of the size of a droplet. A channel has an outlet where droplets are formed. Light is directed at a droplet and partially evaporates liquid in the droplet yielding droplets of a reduced size.

FIG. 22 is a scheme showing a channel having an outlet and droplets. A sensor identifies a droplet of interest and activates a light source to illuminate the droplet of interest. Light from the light source evaporates the liquid in the droplet, removing the droplet of interest from a batch of droplets collected in a droplet reservoir.

### DETAILED DESCRIPTION OF THE INVENTION

The invention provides devices, kits, and systems for forming droplets and methods of their use. The devices may be used to form droplets of a size suitable for utilization as microscale chemical reactors, e.g., for genetic sequencing. In general, droplets are formed by flowing a first liquid through an outlet in the exterior of the device. The invention also provides methods, devices, and systems for changing the size of a droplet or for eliminating a droplet from a plurality of droplets. Droplets of a single liquid (e.g., aqueous phase) or multiple (e.g., 2, 3, 4, 5, or more) liquids (e.g., aqueous phases) may be formed.

The invention provides devices, systems, and methods for forming droplets by liquids exiting from an outlet in the exterior of a device, e.g., by moving an outlet of a channel containing a first liquid across an interface of a second liquid and a fluid to form a droplet of the first liquid in the second liquid, by vibrating a device as liquid is transported through the outlet, or by illuminating a portion of the liquid as the liquid exits from an outlet. By controlling one or more specified droplet generation parameters, the devices and methods may provide droplets or populations of droplets with desirable properties. The devices, systems, and methods described herein provide populations of droplets with consistent features, such as the number of droplets produced, the size of the droplets produced, and the droplet fill ratio (e.g., number of droplets including a specified number of particles versus number of droplets not including a specified number of particles).

Droplet formation as described herein can occur without flowing the continuous phase, unlike in other systems. It will be understood that the continuous phase will be moved during droplet formation, e.g., by the relative motion of the outlet. The invention also provides reservoirs and/or troughs that provide movement of the continuous phase to transport droplets away from the point of contact. This movement may enhance the uniformity of droplets by preventing droplets from contacting each other when formed. For instance, droplet uniformity increases as the degree of coalescence (e.g., between two or more droplets) at the point of contact decreases. The movement of a first droplet away from the point of contact prior to the arrival of a second droplet at the point of contact can decrease or prevent coalescence of the first and second droplet. In one embodiment, preventing contact between droplets can reduce the degree of droplet deformation.

### Devices and Systems

A device of the invention includes a first channel having a depth, a width, a proximal end, and a distal end. The proximal end (i.e., the inlet) is or is configured to be in fluid communication with a source of liquid, e.g., a reservoir integral to the device or coupled to the device, e.g., by tubing. The channel also includes a distal end (i.e., the outlet) that exits the device.

In one embodiment, the first channel has an outlet that is configured to contact a second liquid that is contained in a reservoir. The second liquid has an interface with a fluid, such as air. In some embodiments, the interface is an interface of two liquids (i.e., two immiscible liquids). The second liquid may be oil, for example. The outlet moves relative to the interface of the liquid in the reservoir. The first liquid (i.e., the dispersed phase) is transported through the channel, and as the outlet of the channel crosses the interface of the liquid in the reservoir (i.e., the continuous phase, e.g., oil), a droplet is formed of the first liquid in the second liquid.

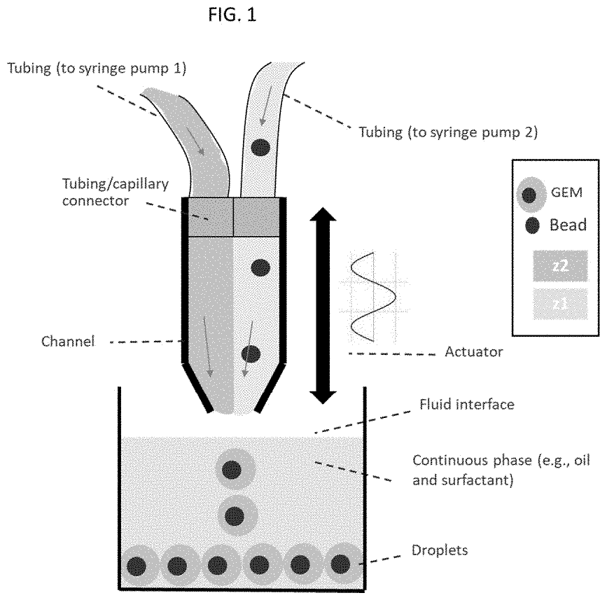

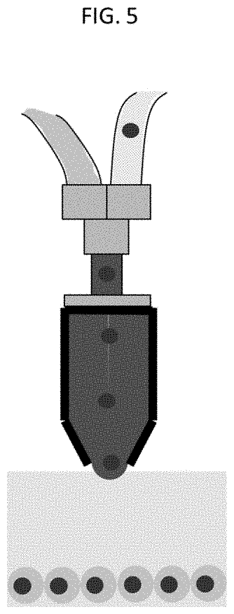

A general scheme of a device in a system is shown in FIG. 1. The system includes the device having a channel with an outlet and a reservoir containing a second liquid (e.g., oil) having an interface with a fluid (e.g., air). In this embodiment, the device includes two inlets upstream of the outlet, and each inlet is connected to a channel containing a liquid. However, one of skill in the art would understand that the channel may contain only a single inlet. Alternatively, the channel may include a plurality of (e.g., 2, 3, 4, 5, 6, 7, 8, 9, 10, or more) inlets. In an embodiment with two liquids, one liquid may contain particles (e.g., biological particles, non-biological particles, or a combination thereof), and the other liquid may not contain particles or contain particles of a different type (e.g., one biological particle and one non-biological particle). The two liquids may mix as they enter the channel through the inlets, e.g., as shown in FIG. 1, or the liquids may mix at the inlet, as shown in FIG. 5.

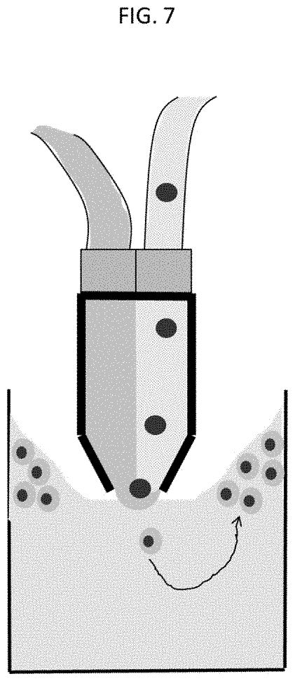

The relative motion alters the vertical position of the device relative to the interface. An actuator may cause motion of the device, the reservoir, or the interface itself, thereby causing relative motion between the outlet and the interface. As the liquid is transported through the outlet, the relative motion of the outlet and the interface causes droplets to form. A droplet may form each time the outlet crosses the interface of the liquid in the reservoir. If the droplets are denser than the liquid in the reservoir, then the droplets sink to the bottom of the reservoir. However, if the droplets are less dense than the liquid in the reservoir, then the droplets rise to the top of the reservoir (FIG. 7). These droplets may be collected in the reservoir.

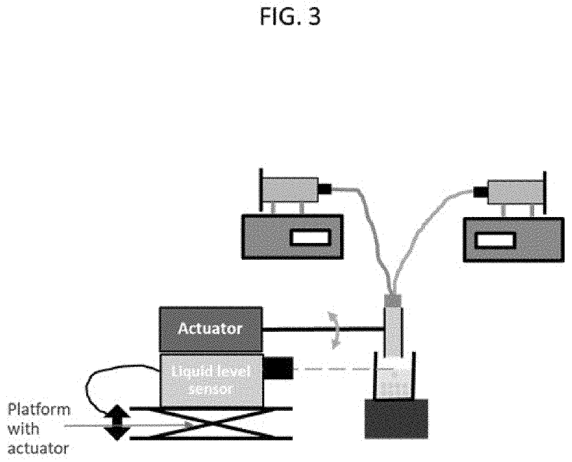

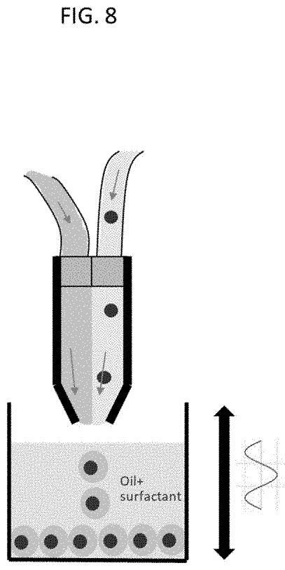

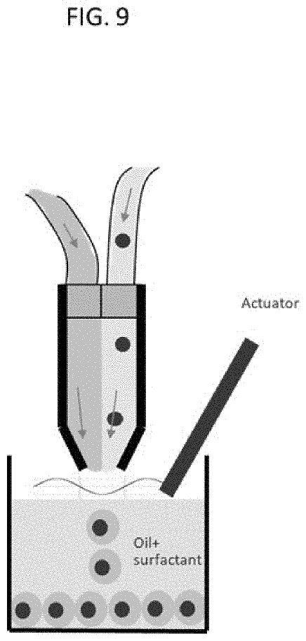

An actuator may be operatively coupled to the device or reservoir to cause relative motion between the outlet and the interface of the liquid in the reservoir. An actuator (e.g., mechanical oscillator) may be operably coupled to the outlet of the device (FIG. 3). In this embodiment, the actuator causes relative motion of the outlet while the reservoir remains substantially stationary. In an alternative embodiment, the actuator is operatively coupled to the reservoir (FIG. 8). In this embodiment, the actuator causes relative motion of the reservoir while the outlet remains substantially stationary. In yet another embodiment, an actuator (e.g., ultrasonic transducer) is operatively coupled to the liquid in the reservoir (FIG. 9). In this embodiment, the actuator moves the interface while the reservoir and the outlet are substantially stationary.

Any suitable actuator may be used to cause relative motion, such as a mechanical oscillator, vibrator, a transducer (e.g., ultrasonic transducer), and the like. Any actuator that causes mechanical motion may be used. The actuator may be operatively coupled to the outlet, the reservoir, the liquid in the reservoir, or a combination thereof. The actuator may include a piezoelectric element, which is described in more detail below. In some embodiments, the actuator produces an acoustic or a mechanical wave, e.g., when coupled to the liquid in the reservoir.

During droplet formation, the vertical level of the liquid in the reservoir may increase during droplet formation. A sensor (e.g., optical sensor) may be used to sense the vertical position of the level of the liquid in the reservoir. This sensor may provide feedback to the actuator, e.g., to calibrate the vertical position of the actuator (FIG. 3).

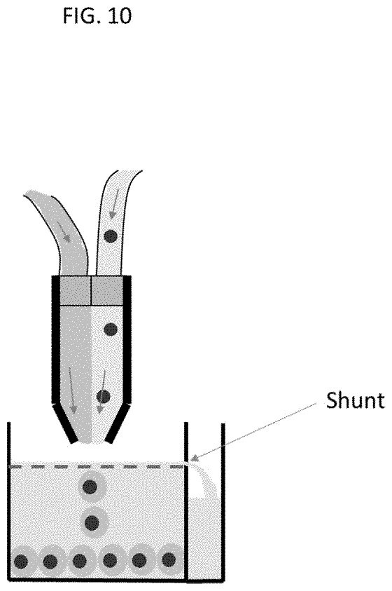

The reservoir may include a shunt (FIG. 10). The shunt is configured to maintain a substantially constant volume of liquid in the reservoir or a substantially constant vertical position of the interface. For example, as droplets are formed and collect in the reservoir, the volume of liquid in the reservoir may increase, thereby changing the vertical position of the interface. The shunt may move liquid out of the reservoir and maintain a substantially constant volume of liquid in the reservoir, thereby providing a substantially constant vertical position of the interface.

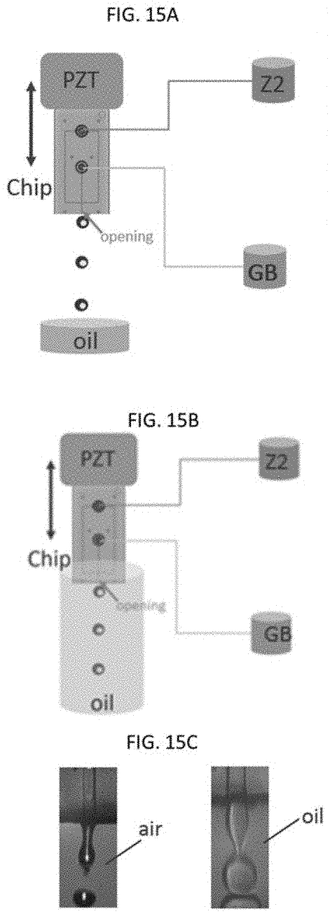

In another embodiment, the device is vibrated to produce droplets. In this embodiment, the device does not need to cross an interface with a second liquid. Droplets are formed as the device is vibrated while liquid exits the device. The outlet of the device may or may not be submerged in an immiscible liquid (FIGS. 15A-15B).

The depth and width of the first channel may be the same, or one may be larger than the other, e.g., the width is larger than the depth, or first depth is larger than the width. In some embodiments, the depth and/or width is between about 0.1 μm and 1000 μm. In some embodiments, the depth and/or width of the first channel is from 1 to 750 μm, 1 to 500 μm, 1 to 250 μm, 1 to 100 μm, 1 to 50 μm, or 3 to 40 μm. In some cases, when the width and length differ, the ratio of the width to depth is, e.g., from 0.1 to 10, e.g., 0.5 to 2 or greater than 3, such as 3 to 10, 3 to 7, or 3 to 5. The width and depths of the first channel may or may not be constant over its length. In particular, the width may increase or decrease adjacent the distal end. In general, channels may be of any suitable cross section, such as a rectangular, triangular, or circular, or a combination thereof. In particular embodiments, a channel may include a groove along the bottom surface. The width or depth of the channel may also increase or decrease, e.g., in discrete portions, to alter the rate of flow of liquid or particles or the alignment of particles.

In another embodiment, the device contains a first channel with an inlet and an outlet. In one embodiment, the first channel contains a liquid, and the liquid is transported through the outlet, where light interacts with the liquid, e.g., causing evaporation. When the liquid exiting the outlet of the first channel crosses the illuminated region, local heating and evaporation of the liquid resulting in droplet formation. The droplet can then be collected in a droplet reservoir.

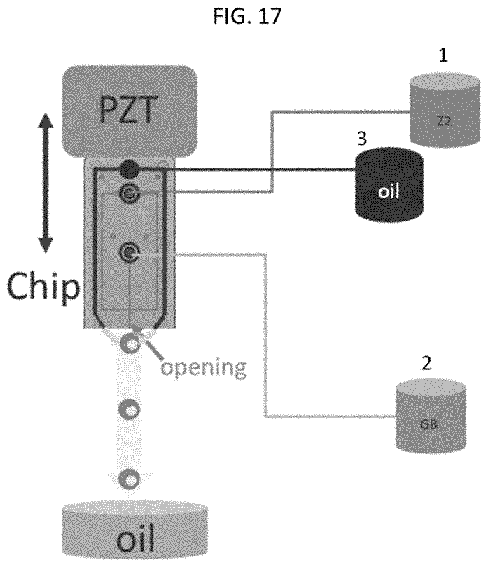

Devices of the invention may also include additional channels that intersect the first channel between its proximal and distal ends, e.g., one or more second channels having a second depth, a second width, a second proximal end, and a second distal end or a third channel having a third depth, width, proximal end, and distal end. Each of the first proximal end and second proximal ends are or are configured to be in fluid communication with, e.g., fluidically connected to, a source of liquid, e.g., a reservoir integral to the device or coupled to the device, e.g., by tubing. The inclusion of one or more intersection channels allows for splitting liquid from the first channel or introduction of liquids into the first channel, e.g., that combine with the liquid in the first channel or do not combine with the liquid in the first channel, e.g., to form a sheath flow. Channels can intersect the first channel at any suitable angle, e.g., from about 5° to about 135° relative to the centerline of the first channel, such as from about 75° to about 115° or from about 85° to about 95°. Additional channels may similarly be present to allow introduction of further liquids or additional flows of the same liquid. Multiple channels can intersect the first channel on the same side or different sides of the first channel. When multiple channels intersect on different sides, the channels may intersect along the length of the first channel to allow liquid introduction at the same point or at different points. The flow rates of liquids from intersecting channels may be selected to control droplet formation. For example, the flow rate of a liquid containing beads and the flow rate of another liquid, e.g., containing cells, can be selected to produce droplets containing single bead (and optionally a single cell). This process allows for super-Poisson loading of droplets. Devices may include one or more additional channels that do not intersect the first channel (or second or third channels present). These channels may have an outlet at the exterior of the device positioned to deliver liquid to droplets as they form (FIG. 17). This liquid may be immiscible with the droplets and coat the droplets as they are formed in a gas environment, e.g., in air. Alternatively, channels may intersect at different points along the length of the first channel. In some instances, a channel configured to direct a liquid including a plurality of particles may have one or more grooves in one or more surfaces of the channel to direct particles towards the intersection. For example, such grooves may increase single occupancy rates of the generated droplets. Additional channels may have any of the structural features discussed above for the first channel.

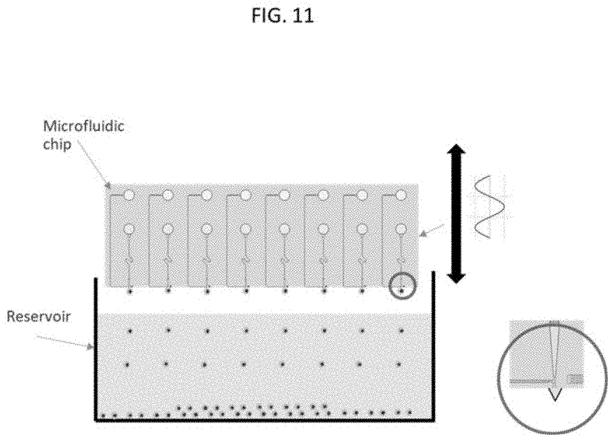

Devices may include multiple first channels, e.g., to increase the rate of droplet formation. In general, throughput may significantly increase by increasing the number of channels or outlets of a device. In some embodiments, the device may include a plurality (e.g., 2, 3, 4, 5, 6, 7, 8, 9, or 10, or more) of channels and/or outlets (FIG. 11). The first liquid (or a different liquid for two or more outlets) may be transported through the outlet of each of the plurality of channels. Relative motion of the outlet of each of the plurality of channels and the interface produces a droplet from each channel. This may provide higher throughput droplet formation than a device with a single channel. For example, a device having five outlets may generate five times as many droplets simultaneously relative to a device having one outlet, provided that the liquid flow rate is substantially the same. A device may have as many outlets as is practical and allowed for the size of the source of liquid, e.g., reservoir. For example, the device may have at least about 2, 3, 4, 5, 6, 7, 8, 9, 10, 20, 30, 40, 50, 60, 70, 80, 90, 100, 150, 200, 250, 300, 350, 400, 450, 500, 600, 700, 800, 900, 1000, 1500, 2000 or more outlets. Inclusion of multiple outlets may require the inclusion of channels that traverse but do not intersect, e.g., the flow path is in a different plane. Multiple first channel may be in fluid communication with, e.g., fluidically connected to, a separate source reservoir and/or a separate outlet. In other embodiments, two or more first channels are in fluid communication with, e.g., fluidically connected to, the same fluid source, e.g., where the multiple first channels branch from a single, upstream channel.

The outlet may contain an optional design feature in which a nozzle is added to the outlet of the channel. The nozzle may be part of the device or a separate feature. The geometry and surface properties of the nozzle may be adjusted to ensure robust droplet generation (FIG. 11).

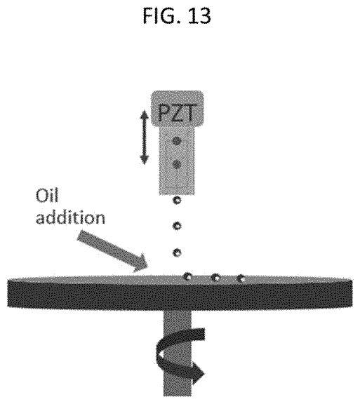

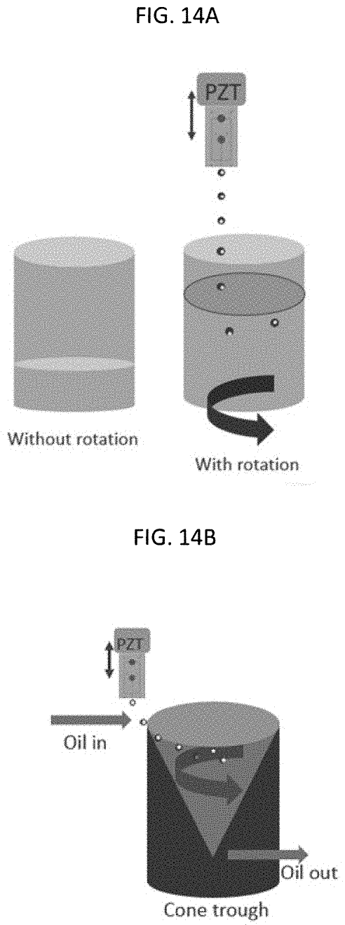

A system may include a reservoir for the second liquid. Additional reservoir(s) may be present, e.g., in the device, to hold other liquids, e.g., the first liquid, or liquids that are combined in the device or liquid to coat droplets as they are formed. In some embodiments the additional reservoir is a part of, e.g., integral to, the device. In other embodiments, the additional reservoir is provided as a separate component. A reservoir may be of any suitable geometry to contain a liquid. The reservoir may house the continuous phase and can be any suitable structure (e.g., a plate (FIG. 13), or a cone (FIGS. 14A and 14B). A reservoir for liquids to flow in additional channels, such as those intersecting the first channel may be present. A single reservoir may also be connected to multiple channels in a device, e.g., when the same liquid is to be introduced at two or more different locations in the device. Waste reservoirs or shunts may also be included to collect waste or overflow when droplets are formed. As described above, the reservoir may include a shunt that maintains a substantially constant vertical position of the liquid in the reservoir, e.g., as droplets are formed. Alternatively, the device may be configured to mate with sources of the liquids, which may be external reservoirs such as vials, tubes, or pouches. Similarly, the device may be configured to mate with a separate component that houses the reservoirs. Reservoirs may be of any appropriate size, e.g., to hold 10 μL to 500 mL, e.g., 10 μL to 300 mL, 25 μL to 10 mL, 100 μL to 1 mL, 40 μL to 300 μL, 1 mL to 10 mL, or 10 mL to 50 mL. When multiple reservoirs are present, each reservoir may have the same or a different size.

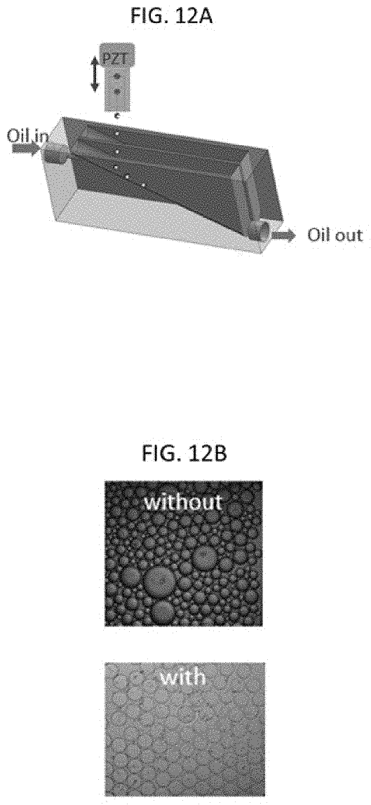

In some embodiments, the reservoir includes or is in fluid communication with a trough with an inlet and outlet (FIG. 12A-C). The trough may have continuous phase flowing through the trough to move the droplets toward a collection reservoir. The trough may be sloped toward the reservoir. The trough may also be conical or similar shape to allow rotational movement of the second liquid. In other embodiments, the reservoir includes or is in fluid communication with is a moving, e.g., rotating or oscillating, plate. Second liquid is delivered to the plate (FIG. 13).

In addition to the components discussed above, devices of the invention can include additional components. For example, channels may include filters to prevent introduction of debris into the device.

In some cases, the microfluidic systems described herein may comprise one or more liquid flow units to direct the flow of one or more liquids, such as the aqueous liquid. In some instances, the liquid flow unit may comprise a compressor to provide positive pressure at an upstream location to direct the liquid from the upstream location to flow to a downstream location. In some instances, the liquid flow unit may comprise a pump to provide negative pressure at a downstream location to direct the liquid from an upstream location to flow to the downstream location. In some instances, the liquid flow unit may comprise both a compressor and a pump, each at different locations. In some instances, the liquid flow unit may comprise different devices at different locations. The liquid flow unit may comprise an actuator. In some instances, where the second liquid is substantially stationary, the reservoir may maintain a constant pressure field at or near each outlet. Devices may also include various valves to control the flow of liquids along a channel or to allow introduction or removal of liquids or droplets from the device.

Suitable valves are known in the art. Valves useful for a device of the present invention include diaphragm valves, solenoid valves, pinch valves, or a combination thereof. Valves can be controlled manually, electrically, magnetically, hydraulically, pneumatically, or by a combination thereof. The device may also include integral liquid pumps or be connectable to a pump to allow for pumping in the first channels and any other channels requiring flow. Examples of pressure pumps include syringe, peristaltic, diaphragm pumps, and sources of vacuum. Other pumps can employ centrifugal or electrokinetic forces. Alternatively, liquid movement may be controlled by gravity, capillarity, or surface treatments. Multiple pumps and mechanisms for liquid movement may be employed in a single device. The device may also include one or more vents to allow pressure equalization, and one or more filters to remove particulates or other undesirable components from a liquid. The device may also include additional inlets and or outlets, e.g., to introduce liquids. Such additional components may be actuated or monitored by one or more controllers or computers operatively coupled to the device, e.g., by being integrated with, physically connected to (mechanically or electrically), or by wired or wireless connection.

Droplet formation may be controlled using one or more piezoelectric elements that cause relative motion between the outlet and the interface. Piezoelectric elements may impart precise control over incremental movements of one or more parts of the device or system during droplet formation. The piezoelectric element may be operatively connected to the outlet, the reservoir, and/or the liquid in the reservoir. Piezoelectric elements may be positioned inside a channel (i.e., in contact with a fluid in the channel), outside the channel (i.e., isolated from the fluid), or a combination thereof. For example, the piezoelectric element may be integrated with the device or coupled or otherwise fastened to the device. Examples of fastenings include, but are not limited to, complementary threading, form-fitting pairs, hooks and loops, latches, threads, screws, staples, clips, clamps, prongs, rings, brads, rubber bands, rivets, grommets, pins, ties, snaps, adhesives (e.g., glue), tapes, vacuum, seals, magnets, or a combination thereof. In some instances, the piezoelectric element can be built into the device. Alternatively, or in addition, the piezoelectric element may be connected to a reservoir or channel or may be a component of a reservoir or device, such as a wall.

The piezoelectric element can have various shapes and sizes. The piezoelectric element may have a shape or cross-section that is circular, triangular, square, rectangular, or partial shapes or combination of shapes thereof. The piezoelectric element can have a thickness from about 100 micrometers (μm) to about 100 millimeters (mm). The piezoelectric element can have a dimension (e.g., cross-section) of at least about 1 mm. The piezoelectric element can be formed of, for example, lead zirconate titanate, zinc oxide, barium titanate, potassium niobate, sodium tungstate, Ba₂NaNb₅O₅, and Pb₂KNb₅O₁₅. The piezoelectric element, for example, can be a piezo crystal. The piezoelectric element may contract when a voltage is applied and return to its original state when the voltage is unapplied. Alternatively, the piezoelectric element may expand when a voltage is applied and return to its original state when the voltage is unapplied. Alternatively, or in addition, application of a voltage to the piezoelectric element can cause mechanical stress, vibration, bending, deformation, compression, decompression, expansion, and/or a combination thereof in its structure, and vice versa (e.g., applying some form of mechanical stress or pressure on the piezoelectric element may produce a voltage). In some instances, the piezoelectric element may include a composite of both piezoelectric material and non-piezoelectric material.

In some cases, a device or system may include a plurality of piezoelectric elements working independently or cooperatively to achieve the desired formation of droplets. For example, a first channel of a device can be coupled to at least 1, 2, 3, 4, 5, 6, 7, 8, 9, 10, 20, 30, 40, 50, 60, 70, 80, 90, 100, 200, 300, 400, or 500 piezoelectric elements. For example, a plurality of piezoelectric elements may each be in electrical communication with the same controller or one or more different controllers.

The frequency of application of electrical charge to the piezoelectric element may be adjusted to control the speed of droplet generation. For example, the frequency of droplet generation may increase with the frequency of alternating electrical charge.

The frequency that drives the electric voltage applied to the piezoelectric element may be from about 5 to about 300 megahertz (MHz). e.g., about 5 MHz, about 6 MHz, about 7 MHz, about MHz, about 9 MHz, about 10 MHz, about 20 MHz, about 30 MHz, about 40 MHz, about 50 MHz, about 60 MHz, about 70 MHz, about 80 MHz, about 90 MHz, about 100 MHz, about 110 MHz, about 120 MHz, about 130 MHz, about 140 MHz, about 150 MHz, about 160 MHz, about 170 MHz, about 180 MHz, about 190 MHz, about 200 MHz, about 210 MHz, about 220 MHz, about 230 MHz, about 240 MHz, about 250 MHz, about 260 MHz, about 270 MHz, about 280 MHz, about 290 MHz, or about 300 MHz. Alternatively, the RF energy may have a frequency range of less than about 5 MHz or greater than about 300 MHz. As will be appreciated, the necessary voltage and/or the RF frequency driving the electric voltage may change with the properties of the piezoelectric element (e.g., efficiency).

In a non-limiting example, the first channel can carry a first fluid (e.g., aqueous) and the reservoir can carry a second fluid (e.g., oil) that is immiscible with the first fluid. The two fluids can communicate at the interface. In some instances, the first fluid in the first channel may include suspended particles. The particles may be non-biological particles, e.g., beads, biological particles, cells, cell beads, or any combination thereof (e.g., a combination of beads and cells or a combination of beads and cell beads, etc.). A discrete droplet generated may include a particle, such as when one or more particles are suspended in the volume of the first fluid that is propelled into the second fluid. Alternatively, a discrete droplet generated may include more than one particle. Alternatively, a discrete droplet generated may not include any particles. In some instances, a discrete droplet generated may contain one or more biological particles where the first fluid in the first channel includes a plurality of biological particles.

The invention further provides elements that enhance the capacity of the reservoir to collect droplets. For example, the reservoir can be configured to shunt the continuous phase to a separate reservoir (i.e., a continuous phase reservoir) as droplets accumulate in the reservoir. A shunt can feature one or more openings (e.g., one, two, three, four, or more openings) that render the reservoir in fluid communication with a continuous phase reservoir. The one or more openings can be positioned to prevent droplets from flowing into the continuous phase reservoir while allowing the continuous phase to freely pass in and out. For example, the one or more openings can be disposed near the bottom of the reservoir. Additionally, or alternatively, the one or more openings can be positioned to either side of the outlet as the droplets emerge.

Devices of the invention may be combined with various external components, e.g., pumps, reservoirs, sensors (e.g., temperature sensors, pressure sensors, optical sensors, such as liquid level sensors), controllers (e.g., flow rate controllers), actuators (e.g., mechanical oscillators, vibrators, transducers, e.g., ultrasonic transducers), platforms, shakers, reagents, e.g., analyte moieties, liquids, particles (e.g., beads), and/or samples in the form of kits and systems.

A system described herein may include, for example, a device as described herein and an actuator that causes relative motion of the outlet and the interface. The system may include a device, an actuator, and a reservoir that contains a continuous phase (e.g., oil) for droplet formation. The system may include a plurality (e.g., 2, 3, 4, 5, 6, 7, 8, 9. 10, or more) actuators. For example, the system may include an actuator operatively coupled to the first channel, the reservoir, and/or the interface of the liquid in the reservoir, or a combination thereof. The system may include a platform to hold the reservoir. The platform may be connected to the actuator to move the platform up and down, thereby causing relative motion of the interface of the liquid in the reservoir.

A device and/or system herein described may include a source of electromagnetic energy (e.g., a light source). In some embodiments, light from the light source (e.g., a laser, a light-emitting diode (LED), a broadband source, a halogen lamp) is focused on a region of the liquid exiting the device outlet (. The source of electromagnetic energy can have an output wavelength from about 100 nm to about 1 mm (e.g., from about 100 nm to about 1,000 nm, e.g., about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm, or about 1000 nm), or (e.g., from about 1,000 nm to about 10,000 nm, e.g., about 1,050 nm, about 1,100 nm, about 1,150 nm, about 1,200 nm, about 1,250 nm, about 1,300 nm, about 1,350 nm, about 1,400 nm, about 1,450 nm, about 1,500 nm, about 1,550 nm, about 1,600 nm, about 1,650 nm, about 1,700 nm, about 1,750 nm, about 1,800 nm, about 1,850 nm, about 1,900 nm, about 2,000 nm, about 3,000 nm, about 4,000 nm, about 5,000 nm, about 6,000 nm, about 7,000 nm, about 8,000 nm, about 9,000 nm, or about 10,000 nm), or (e.g., from about 10,000 nm to about 100,000 nm, e.g., about 20,000 nm, about 30,000 nm, about 40,000 nm, about 50,000 nm, about 60,000 nm, about 70,000 nm, about 80,000 nm, about 90,000 nm, or about 100,000 nm), or (e.g., from about 100,000 nm to about 1,000,000 nm, e.g., about 200,000 nm, about 300,000 nm, about 400,000 nm, about 500,000 nm, about 600,000 nm, about 700,000 nm, about 800,000 nm, about 900,000 nm, or about 1,000,000 nm). A single source of electromagnetic energy may illuminate one or more streams of liquids or droplets outside of a device. Multiple sources may also be used for multiple streams of liquids or droplets. In some embodiments the source provides continuous illumination. The power density of the illumination can be from about 1 W/mm² to about 1,000 W/mm² (e.g., from about 1 W/mm² to about 10 W/mm², e.g., about 1.5 W/mm², about 2.0 W/mm², about 2.5 W/mm², about 3.0 W/mm², about 3.5 W/mm², about 4.0 W/mm², about 4.5 W/mm², about 5.0 W/mm², about 5.5 W/mm², about 6.0 W/mm², about 6.5 W/mm², about 7.0 W/mm², about 7.5 W/mm², about 8.0 W/mm², about 8.5 W/mm², about 9.0 W/mm², about 9.5 W/mm², about 10.0 W/mm²), or (e.g., from about 10 W/mm² to about 100 W/mm², e.g., about 15 W/mm², about 20 W/mm², about 25 W/mm², about 30 W/mm², about 35 W/mm², about 40 W/mm², about 45 W/mm², about 50 W/mm², about 55 W/mm², about 60 W/mm², about 65 W/mm², about 70 W/mm², about 75 W/mm², about 80 W/mm², about 85 W/mm², about 90 W/mm², about 95 W/mm², or about 100 W/mm²), or (e.g., from about 100 W/mm² to about 1,000 W/mm², e.g., about 150 W/mm², about 200 W/mm², about 250 W/mm², about 300 W/mm², about 350 W/mm², about 400 W/mm², about 450 W/mm², about 500 W/mm², about 550 W/mm², about 600 W/mm², about 650 W/mm², about 700 W/mm², about 750 W/mm², about 800 W/mm², about 850 W/mm², about 900 W/mm², about 950 W/mm², or about 1,000 W/mm²). In some embodiments, the source of electromagnetic energy provides pulsed illumination, e.g., at a frequency from about 0.1 Hz to about 1,000,000 Hz (e.g., from about 0.1 Hz to about 1.0 Hz, e.g., about 0.2 Hz, about 0.3 Hz, about 0.4 Hz, about 0.5 Hz, about 0.6 Hz, about 0.7 Hz, about 0.8 Hz, about 0.9 Hz, or about 1.0 Hz), or (e.g., from about 1.0 Hz to about 10 Hz, e.g., about 1.5 Hz, about 2.0 Hz, about 2.5 Hz, about 3.0 Hz, about 3.5 Hz, about 4.0 Hz, about 4.5 Hz, about 5.0 Hz, about 5.5 Hz, about 6.0 Hz, about 6.5 Hz, about 7.0 Hz, about 7.5 Hz, about 8.0 Hz, about 8.5 Hz, about 9.0 Hz, about 9.5 Hz, or about 10 Hz), or (e.g., from about 10 Hz to about 100 Hz, e.g., about 15 Hz, about 20 Hz, about 25 Hz, about 30 Hz, about 35 Hz, about 40 Hz, about 45 Hz, about 50 Hz, about 55 Hz, about 60 Hz, about 65 Hz, about 70 Hz, about 75 Hz, about 80 Hz, about 85 Hz, about 90 Hz, about 95 Hz, or about 100 Hz), or (e.g., from about 100 Hz to about 1,000 Hz, e.g., about 150 Hz, about 200 Hz, about 250 Hz, about 300 Hz, about 350 Hz, about 400 Hz, about 450 Hz, about 500 Hz, about 550 Hz, about 600 Hz, about 650 Hz, about 700 Hz, about 750 Hz, about 800 Hz, about 850 Hz, about 900 Hz, about 950 Hz, or about 1,000 Hz), or (e.g., from about 1,000 Hz to about 10,000 Hz, e.g., about 1,500 Hz, about 2,000 Hz, about 2,500 Hz, about 3,000 Hz, about 3,500 Hz, about 4,000 Hz, about 4,500 Hz, about 5,000 Hz, about 5,500 Hz, about 6,000 Hz, about 6,500 Hz, about 7,000 Hz, about 7,500 Hz, about 8,000 Hz, about 8,500 Hz, about 9,000 Hz, about 9,500 Hz, or about 10,000 Hz), (e.g., from about 10,000 Hz to about 100,000 Hz, e.g., about 15,000 Hz, about 20,000 Hz, about 25,000 Hz, about 30,000 Hz, about 35,000 Hz, about 40,000 Hz, about 45,000 Hz, about 50,000 Hz, about 55,000 Hz, about 60,000 Hz, about 65,000 Hz, about 70,000 Hz, about 75,000 Hz, about 80,000 Hz, about 85,000 Hz, about 90,000 Hz, about 95,000 Hz, or about 100,000 Hz), or (e.g., from about 100,000 Hz to about 1,000,000 Hz, e.g., about 150,000 Hz, about 200,000 Hz, about 250,000 Hz, about 300,000 Hz, about 350,000 Hz, about 400,000 Hz, about 450,000 Hz, about 500,000 Hz, about 550,000 Hz, about 600,000 Hz, about 650,000 Hz, about 700,000 Hz, about 750,000 Hz, about 800,000 Hz, about 850,000 Hz, about 900,000 Hz, about 950,000 Hz, or about 1,000,000 Hz).

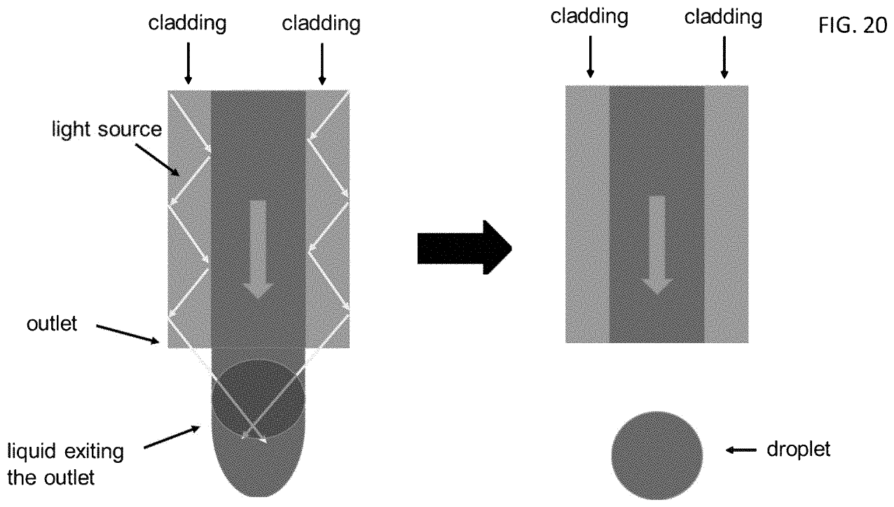

In addition, or in the alternative, electromagnetic energy is directed through the fluidic device by a light guide, e.g., a cladding around the first channel, that delivers the energy to the outlet of the first channel (FIG. 20). The energy can originate from an external source or from a source internal to the device. In some embodiments, energy can be divided in the device by light guides and directed to a plurality of outlets.

In some embodiments, a sensor, e.g., an optical sensor, can be connected to the systems and devices to detect and/or identify a droplet of interest. In some embodiments a droplet of interest may be a droplet to be evaporated, e.g., a droplet not containing one or more particles, molecules, or solutes of interest, from a plurality of droplets.

### Surface Properties

A surface of the device, such as the surface of the exterior of a microfluidic chip around the outlet, may include a material, e.g., bulk material or coating, with or without surface texture, that determines the physical properties of the device. In particular, the flow of liquids through a device of the invention may be controlled by the device surface properties (e.g., wettability of a liquid-contacting surface). In some cases, a device portion (e.g., a channel or outlet) may have a surface having a wettability suitable for facilitating liquid flow (e.g., in a channel) or assisting droplet formation of a first liquid in a second liquid (e.g., at an outlet).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method. A device may include a channel having a surface with a first wettability in fluid communication with (e.g., fluidically connected to) the exterior of a microfluidic chip around the outlet or a reservoir having a surface with a second wettability. The wettability of each surface may be suited to producing droplets (e.g., of a first liquid in a second liquid). In this non-limiting example, the channel carrying the first liquid may have a surface with a first wettability suited for the first liquid wetting the channel surface. For example, when the first liquid is substantially miscible with water (e.g., the first liquid is an aqueous liquid), the surface material or coating may have a water contact angle of about 95° or less (e.g., 90° or less). Additionally, in this non-limiting example, the exterior of the device or the reservoir may have a surface with a second wettability so that the first liquid dewets from the exterior of the device. For example, when the second liquid is substantially immiscible with water (e.g., the second liquid is an oil), the material or coating used around the outlet may have a water contact angle of about 70° or more (e.g., 90° or more, 95° or more, or 100° or more). Typically, in this non-limiting example, the exterior of the device around the outlet will be more hydrophobic than the channel. For example, the water contact angles of the materials or coatings employed in the channel and the exterior around the outlet will differ by 5° to 100°.

For example, portions of the device carrying aqueous phases (e.g., a channel) may have a surface material or coating that is hydrophilic or more hydrophilic than the exterior of the device, e.g., include a material or coating having a water contact angle of less than or equal to about 90°. Alternatively or in addition, the exterior of the device around the outlet may have a surface material or coating that the liquid in the droplets does not wet, e.g., include a material or coating having a contact angle of greater than 70° (e.g., greater than 90°, greater than 95°, greater than 100°, greater than 110°, (e.g., 95°-180° or 100°-120°)). In certain embodiments, the exterior of the device around the outlet may include a material or surface coating that reduces or prevents or reduces wetting by aqueous phases, e.g., water. The device can be designed to have a single type of material or coating throughout. Alternatively, the device may have separate regions having different materials or coatings. Surface textures may also be employed to control fluid flow. When different materials or coatings are applied around the outlet, the material or coating may extend by at least 0.01 mm, 0.05 mm, 0.1 mm, 0.25 mm, 0.5 mm, 1 mm, 5 mm, 1 cm, or to the extent of the device around the outlet. In other embodiments, the material or coating extends by at least twice the cross-section of the outlet.

In addition or in the alternative, portions of the device carrying or contacting oil phases (e.g., a channel or exterior) may have a surface material or coating that is hydrophobic, fluorophilic, or more hydrophobic or fluorophilic than the portions of the device that contact aqueous phases, e.g., include a material or coating having a water contact angle of greater than or equal to about 90°. Alternatively or in addition, the exterior of the device around an outlet that dispenses continuous phase may have a surface material or coating that the continuous phase does not wet, e.g., include a material or coating having a contact angle of greater than 70° (e.g., greater than 90°, greater than 95°, greater than 100°, greater than 110°, (e.g., 95°-180° or 100°-120°)). In certain embodiments, the exterior of the device around the outlet may include a material or surface coating that reduces or prevents or reduces wetting by oil phases, e.g., a fluorophilic oil. The device can be designed to have a single type of material or coating throughout. Alternatively, the device may have separate regions having different materials or coatings. Surface textures may also be employed to control fluid flow. When different materials or coatings are applied around the outlet, the material or coating may extend by at least 0.01 mm, 0.05 mm, 0.1 mm, 0.25 mm, 0.5 mm, 1 mm, 5 mm, 1 cm, or to the extent of the device around the outlet. In other embodiments, the material or coating extends by at least twice the cross-section of the outlet.

The device surface properties may be those of a native surface (i.e., the surface properties of the bulk material used for the device fabrication) or of a surface treatment. Non-limiting examples of surface treatments include, e.g., surface coatings and surface textures. In one approach, the device surface properties are attributable to one or more surface coatings present in a device portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the device. Example metal oxides useful for coating surfaces include, but are not limited to, Al₂O₃, TiO₂, SiO₂, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al₂O₃ can be deposited on a surface by contacting it with trimethylaluminum (TMA) and water.

In another approach, the device surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO₂/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoroethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about) 150°.

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

The above discussion centers on the water contact angle. It will be understood that liquids employed in the devices and methods of the invention may not be water, or even aqueous. Accordingly, the actual contact angle of a liquid on a surface of the device may differ from the water contact angle. Furthermore, the determination of a water contact angle of a material or coating can be made on that material or coating when not incorporated into a device or system of the invention.

### Particles

The invention includes devices, systems, and kits having particles, e.g., for use in analysis. For example, particles configured with analyte moieties (e.g., barcodes, nucleic acids, binding molecules (e.g., proteins, peptides, aptamers, antibodies, or antibody fragments), enzymes, substrates, cells or particulate components thereof, etc.) can be included in a droplet containing an analyte to modify the analyte and/or detect the presence or concentration of the analyte. In some embodiments, particles are synthetic particles (e.g., beads, e.g., gel beads).

For example, a droplet may include one or more analyte moieties, e.g., unique identifiers, such as barcodes. Analyte moieties, e.g., barcodes, may be introduced into droplets previous to, subsequent to, or concurrently with droplet formation. The delivery of the analyte moieties, e.g., barcodes, to a particular droplet allows for the later attribution of the characteristics of an individual sample (e.g., biological particle) to the particular droplet. Analyte moieties, e.g., barcodes, may be delivered, for example on a nucleic acid (e.g., an oligonucleotide), to a droplet via any suitable mechanism. Analyte moieties, e.g., barcoded nucleic acids (e.g., oligonucleotides), can be introduced into a droplet via a particle, such as a microcapsule. In some cases, analyte moieties, e.g., barcoded nucleic acids (e.g., oligonucleotides), can be initially associated with the particle (e.g., microcapsule) and then released upon application of a stimulus which allows the analyte moieties, e.g., nucleic acids (e.g., oligonucleotides), to dissociate or to be released from the particle.

A particle, e.g., a bead, may be porous, non-porous, hollow (e.g., a microcapsule), solid, semi-solid, semi-fluidic, fluidic, and/or a combination thereof. In some instances, a particle, e.g., a bead, may be dissolvable, disruptable, and/or degradable. In some cases, a particle, e.g., a bead, may not be degradable. In some cases, the particle, e.g., a bead, may be a gel bead. A gel bead may be a hydrogel bead. A gel bead may be formed from molecular precursors, such as a polymeric or monomeric species. A semi-solid particle, e.g., a bead, may be a liposomal bead. Solid particles, e.g., beads, may comprise metals including iron oxide, gold, and silver. In some cases, the particle, e.g., the bead, may be a silica bead. In some cases, the particle, e.g., a bead, can be rigid. In other cases, the particle, e.g., a bead, may be flexible and/or compressible.

A particle, e.g., a bead, may comprise natural and/or synthetic materials. For example, a particle, e.g., a bead, can comprise a natural polymer, a synthetic polymer or both natural and synthetic polymers. Examples of natural polymers include proteins and sugars such as deoxyribonucleic acid, rubber, cellulose, starch (e.g., amylose, amylopectin), proteins, enzymes, polysaccharides, silks, polyhydroxyalkanoates, chitosan, dextran, collagen, carrageenan, ispaghula, acacia, agar, gelatin, shellac, sterculia gum, xanthan gum, corn sugar gum, guar gum, gum karaya, agarose, alginic acid, alginate, or natural polymers thereof. Examples of synthetic polymers include acrylics, nylons, silicones, spandex, viscose rayon, polycarboxylic acids, polyvinyl acetate, polyacrylamide, polyacrylate, polyethylene glycol, polyurethanes, polylactic acid, silica, polystyrene, polyacrylonitrile, polybutadiene, polycarbonate, polyethylene, polyethylene terephthalate, poly(chlorotrifluoroethylene), poly(ethylene oxide), poly(ethylene terephthalate), polyethylene, polyisobutylene, poly(methyl methacrylate), poly(oxymethylene), polyformaldehyde, polypropylene, polystyrene, poly(tetrafluoroethylene), poly(vinyl acetate), poly(vinyl alcohol), poly(vinyl chloride), poly(vinylidene dichloride), poly(vinylidene difluoride), poly(vinyl fluoride) and/or combinations (e.g., co-polymers) thereof. Beads may also be formed from materials other than polymers, including lipids, micelles, ceramics, glass-ceramics, material composites, metals, other inorganic materials, and others.

In some instances, the particle, e.g., the bead, may contain molecular precursors (e.g., monomers or polymers), which may form a polymer network via polymerization of the molecular precursors. In some cases, a precursor may be an already polymerized species capable of undergoing further polymerization via, for example, a chemical cross-linkage. In some cases, a precursor can comprise one or more of an acrylamide or a methacrylamide monomer, oligomer, or polymer. In some cases, the particle, e.g., the bead, may comprise prepolymers, which are oligomers capable of further polymerization. For example, polyurethane beads may be prepared using prepolymers. In some cases, the particle, e.g., the bead, may contain individual polymers that may be further polymerized together. In some cases, particles, e.g., beads, may be generated via polymerization of different precursors, such that they comprise mixed polymers, co-polymers, and/or block co-polymers. In some cases, the particle, e.g., the bead, may comprise covalent or ionic bonds between polymeric precursors (e.g., monomers, oligomers, linear polymers), oligonucleotides, primers, and other entities. In some cases, the covalent bonds can be carbon-carbon bonds or thioether bonds.

Cross-linking may be permanent or reversible, depending upon the particular cross-linker used. Reversible cross-linking may allow for the polymer to linearize or dissociate under appropriate conditions. In some cases, reversible cross-linking may also allow for reversible attachment of a material bound to the surface of a bead. In some cases, a cross-linker may form disulfide linkages. In some cases, the chemical cross-linker forming disulfide linkages may be cystamine or a modified cystamine.

Particles, e.g., beads, may be of uniform size or heterogeneous size. In some cases, the diameter of a particle, e.g., a bead, may be at least about 1 micrometer (μm), 5 μm, 10 μm, 20 μm, 30 μm, 40 μm, 50 μm, 60 μm, 70 μm, 80 μm, 90 μm, 100 μm, 250 μm, 500 μm, 1 mm, or greater. In some cases, a particle, e.g., a bead, may have a diameter of less than about 1 μm, 5 μm, 10 μm, 20 μm, 30 μm, 40 μm, 50 μm, 60 μm, 70 μm, 80 μm, 90 μm, 100 μm, 250 μm, 500 μm, 1 mm, or less. In some cases, a particle, e.g., a bead, may have a diameter in the range of about 40-75 μm, 30-75 μm, 20-75 μm, 40-85 μm, 40-95 μm, 20-100 μm, 10-100 μm, 1-100 μm, 20-250 μm, or 20-500 μm. The size of a particle, e.g., a bead, e.g., a gel bead, used to produce droplets is typically on the order of a cross section of the first channel (width or depth). In some cases, the gel beads are larger than the width and/or depth of the first channel and/or shelf, e.g., at least 1.5×, 2×, 3×, or 4× larger than the width and/or depth of the first channel and/or shelf.

In certain embodiments, particles, e.g., beads, can be provided as a population or plurality of particles, e.g., beads, having a relatively monodisperse size distribution. Where it may be desirable to provide relatively consistent amounts of reagents within droplets, maintaining relatively consistent particle, e.g., bead, characteristics, such as size, can contribute to the overall consistency. In particular, the particles, e.g., beads, described herein may have size distributions that have a coefficient of variation in their cross-sectional dimensions of less than 50%, less than 40%, less than 30%, less than 20%, and in some cases less than 15%, less than 10%, less than 5%, or less.

Particles may be of any suitable shape. Examples of particles, e.g., beads, shapes include, but are not limited to, spherical, non-spherical, oval, oblong, amorphous, circular, cylindrical, and variations thereof.

A particle, e.g., bead, injected or otherwise introduced into a droplet may comprise releasably, cleavably, or reversibly attached analyte moieties (e.g., barcodes). A particle, e.g., bead, injected or otherwise introduced into a droplet may comprise activatable analyte moieties (e.g., barcodes). A particle, e.g., bead, injected or otherwise introduced into a droplet may be a degradable, disruptable, or dissolvable particle, e.g., dissolvable bead.

Particles, e.g., beads, within a first channel may flow at a substantially regular flow profile (e.g., at a regular flow rate). Such regular flow profiles can permit a droplet, when formed, to include a single particle (e.g., bead) and a single cell or other biological particle. Such regular flow profiles may permit the droplets to have an dual occupancy (e.g., droplets having at least one bead and at least one cell or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. In some embodiments, the droplets have a 1:1 dual occupancy (i.e., droplets having exactly one particle (e.g., bead) and exactly one cell or other biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99% of the population. Such regular flow profiles and devices that may be used to provide such regular flow profiles are provided, for example, in U.S. Patent Publication No. 2015/0292988, which is entirely incorporated herein by reference.

As discussed above, analyte moieties (e.g., barcodes) can be releasably, cleavably or reversibly attached to the particles, e.g., beads, such that analyte moieties (e.g., barcodes) can be released or be releasable through cleavage of a linkage between the barcode molecule and the particle, e.g., bead, or released through degradation of the particle (e.g., bead) itself, allowing the barcodes to be accessed or be accessible by other reagents, or both. Releasable analyte moieties (e.g., barcodes) may sometimes be referred to as activatable analyte moieties (e.g., activatable barcodes), in that they are available for reaction once released. Thus, for example, an activatable analyte moiety (e.g., activatable barcode) may be activated by releasing the analyte moiety (e.g., barcode) from a particle, e.g., bead (or other suitable type of droplet described herein). Other activatable configurations are also envisioned in the context of the described methods and systems.

In addition to, or as an alternative to the cleavable linkages between the particles, e.g., beads, and the associated moieties, such as barcode containing nucleic acids (e.g., oligonucleotides), the particles, e.g., beads may be degradable, disruptable, or dissolvable spontaneously or upon exposure to one or more stimuli (e.g., temperature changes, pH changes, exposure to particular chemical species or phase, exposure to light, reducing agent, etc.). In some cases, a particle, e.g., bead, may be dissolvable, such that material components of the particle, e.g., bead, are degraded or solubilized when exposed to a particular chemical species or an environmental change, such as a change temperature or a change in pH. In some cases, a gel bead can be degraded or dissolved at elevated temperature and/or in basic conditions. In some cases, a particle, e.g., bead, may be thermally degradable such that when the particle, e.g., bead, is exposed to an appropriate change in temperature (e.g., heat), the particle, e.g., bead, degrades. Degradation or dissolution of a particle (e.g., bead) bound to a species (e.g., a nucleic acid, e.g., an oligonucleotide, e.g., barcoded oligonucleotide) may result in release of the species from the particle, e.g., bead. As will be appreciated from the above disclosure, the degradation of a particle, e.g., bead, may refer to the disassociation of a bound or entrained species from a particle, e.g., bead, both with and without structurally degrading the physical particle, e.g., bead, itself. For example, entrained species may be released from particles, e.g., beads, through osmotic pressure differences due to, for example, changing chemical environments. By way of example, alteration of particle, e.g., bead, pore sizes due to osmotic pressure differences can generally occur without structural degradation of the particle, e.g., bead, itself. In some cases, an increase in pore size due to osmotic swelling of a particle, e.g., bead or microcapsule (e.g., liposome), can permit the release of entrained species within the particle. In other cases, osmotic shrinking of a particle may cause the particle, e.g., bead, to better retain an entrained species due to pore size contraction.

A degradable particle, e.g., bead, may be introduced into a droplet, such as a droplet of an emulsion or a well, such that the particle, e.g., bead, degrades within the droplet and any associated species (e.g., nucleic acids, oligonucleotides, or fragments thereof) are released within the droplet when the appropriate stimulus is applied. The free species (e.g., nucleic acid, oligonucleotide, or fragment thereof) may interact with other reagents contained in the droplet. For example, a polyacrylamide bead comprising cystamine and linked, via a disulfide bond, to a barcode sequence, may be combined with a reducing agent within a droplet of a water-in-oil emulsion. Within the droplet, the reducing agent can break the various disulfide bonds, resulting in particle, e.g., bead, degradation and release of the barcode sequence into the aqueous, inner environment of the droplet. In another example, heating of a droplet comprising a particle-, e.g., bead-, bound analyte moiety (e.g., barcode) in basic solution may also result in particle, e.g., bead, degradation and release of the attached barcode sequence into the aqueous, inner environment of the droplet.

Any suitable number of analyte moieties (e.g., molecular tag molecules (e.g., primer, barcoded oligonucleotide, etc.)) can be associated with a particle, e.g., bead, such that, upon release from the particle, the analyte moieties (e.g., molecular tag molecules (e.g., primer, e.g., barcoded oligonucleotide, etc.)) are present in the droplet at a pre-defined concentration. Such pre-defined concentration may be selected to facilitate certain reactions for generating a sequencing library, e.g., amplification, within the droplet. In some cases, the pre-defined concentration of a primer can be limited by the process of producing oligonucleotide-bearing particles, e.g., beads.

Additional reagents may be included as part of the particles (e.g., analyte moieties) and/or in solution or dispersed in the droplet, for example, to activate, mediate, or otherwise participate in a reaction, e.g., between the analyte and analyte moiety.

### Biological Samples

A droplet of the present disclosure may include one or more biological particles (e.g., cells or nuclei) and/or macromolecular constituents thereof (e.g., components of cells (e.g., intracellular or extracellular proteins, nucleic acids, glycans, or lipids) or products of cells (e.g., secretion products)). An analyte from a biological particle, e.g., component or product thereof, may be considered to be a bioanalyte. In some embodiments, a biological particle, e.g., cell or nuclei, or product thereof is included in a droplet, e.g., with one or more particles (e.g., beads) having an analyte moiety. A biological particle, e.g., cell or nuclei, and/or components or products thereof can, in some embodiments, be encased inside a gel, such as via polymerization of a droplet containing the biological particle and precursors capable of being polymerized or gelled.

In the case of encapsulated biological particles (e.g., cells or nuclei), a biological particle may be included in a droplet that contains lysis reagents in order to release the contents (e.g., contents containing one or more analytes (e.g., bioanalytes)) of the biological particles within the droplet. In such cases, the lysis agents can be contacted with the biological particle suspension concurrently with, or immediately prior to the introduction of the biological particles into the outlet, for example, through an additional channel or channels upstream or proximal to a second channel or a third channel that is upstream or proximal to a second outlet. Examples of lysis agents include bioactive reagents, such as lysis enzymes that are used for lysis of different cell types, e.g., gram positive or negative bacteria, plants, yeast, mammalian, etc., such as lysozymes, achromopeptidase, lysostaphin, labiase, kitalase, lyticase, and a variety of other lysis enzymes available from, e.g., Sigma-Aldrich, Inc. (St Louis, Mo.), as well as other commercially available lysis enzymes. Other lysis agents may additionally or alternatively be contained in a droplet with the biological particles (e.g., cells or nuclei) to cause the release of the biological particles' contents into the droplets. For example, in some cases, surfactant-based lysis solutions may be used to lyse biological particles (e.g., cells or nuclei), although these may be less desirable for emulsion-based systems where the surfactants can interfere with stable emulsions. In some cases, lysis solutions may include non-ionic surfactants such as, for example, TRITON X-100™ and TWEEN 20™. In some cases, lysis solutions may include ionic surfactants such as, for example, sarcosyl and sodium dodecyl sulfate (SDS). In some embodiments, lysis solutions are hypotonic, thereby lysing biological particles (e.g., cells or nuclei) by osmotic shock. Electroporation, thermal, acoustic or mechanical cellular disruption may also be used in certain cases, e.g., non-emulsion-based droplet formation such as encapsulation of biological particles that may be in addition to or in place of droplet formation, where any pore size of the encapsulate is sufficiently small to retain nucleic acid fragments of a desired size, following cellular disruption.

In addition to the lysis agents, other reagents can also be included in droplets with the biological particles, including, for example, DNase and RNase inactivating agents or inhibitors, such as proteinase K, chelating agents, such as EDTA, and other reagents employed in removing or otherwise reducing negative activity or impact of different cell lysate components on subsequent processing of nucleic acids. In addition, in the case of encapsulated biological particles (e.g., cells or nuclei), the biological particles may be exposed to an appropriate stimulus to release the biological particles or their contents from a microcapsule within a droplet. For example, in some cases, a chemical stimulus may be included in a droplet along with an encapsulated biological particle to allow for degradation of the encapsulating matrix and release of the cell or its contents into the larger droplet. In some cases, this stimulus may be the same as the stimulus described elsewhere herein for release of analyte moieties (e.g., oligonucleotides) from their respective particle (e.g., bead). In alternative aspects, this may be a different and non-overlapping stimulus, in order to allow an encapsulated biological particle to be released into a droplet at a different time from the release of analyte moieties (e.g., oligonucleotides) into the same droplet.

Additional reagents may also be included in droplets with the biological particles, such as endonucleases to fragment a biological particle's DNA, DNA polymerase enzymes and dNTPs used to amplify the biological particle's nucleic acid fragments and to attach the barcode molecular tags to the amplified fragments. Other reagents may also include reverse transcriptase enzymes, including enzymes with terminal transferase activity, primers and oligonucleotides, and switch oligonucleotides (also referred to herein as “switch oligos” or “template switching oligonucleotides”) which can be used for template switching. In some cases, template switching can be used to increase the length of a cDNA. In some cases, template switching can be used to append a predefined nucleic acid sequence to the cDNA. In an example of template switching, cDNA can be generated from reverse transcription of a template, e.g., cellular mRNA, where a reverse transcriptase with terminal transferase activity can add additional nucleotides, e.g., polyC, to the cDNA in a template independent manner. Switch oligos can include sequences complementary to the additional nucleotides, e.g., polyG. The additional nucleotides (e.g., polyC) on the cDNA can hybridize to the additional nucleotides (e.g., polyG) on the switch oligo, whereby the switch oligo can be used by the reverse transcriptase as template to further extend the cDNA. Template switching oligonucleotides may comprise a hybridization region and a template region. The hybridization region can comprise any sequence capable of hybridizing to the target. In some cases, as previously described, the hybridization region comprises a series of G bases to complement the overhanging C bases at the 3′ end of a cDNA molecule. The series of G bases may comprise 1 G base, 2 G bases, 3 G bases, 4 G bases, 5 G bases or more than 5 G bases. The template sequence can comprise any sequence to be incorporated into the cDNA. In some cases, the template region comprises at least 1 (e.g., at least 2, 3, 4, 5 or more) tag sequences and/or functional sequences. Switch oligos may comprise deoxyribonucleic acids; ribonucleic acids; modified nucleic acids including 2-Aminopurine, 2,6-Diaminopurine (2-Amino-dA), inverted dT, 5-Methyl dC, 2′-deoxyinosine, Super T (5-hydroxybutyl-2′-deoxyuridine), Super G (8-aza-7-deazaguanosine), locked nucleic acids (LNAs), unlocked nucleic acids (UNAs, e.g., UNA-A, UNA-U, UNA-C, UNA-G), Iso-dG, Iso-dC, 2′ Fluoro bases (e.g., Fluoro C, Fluoro U, Fluoro A, and Fluoro G), or any combination.

In some cases, the length of a switch oligo may be 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249, 250 nucleotides or longer.

In some cases, the length of a switch oligo may be at least 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides or longer.

In some cases, the length of a switch oligo may be at most 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150, 151, 152, 153, 154, 155, 156, 157, 158, 159, 160, 161, 162, 163, 164, 165, 166, 167, 168, 169, 170, 171, 172, 173, 174, 175, 176, 177, 178, 179, 180, 181, 182, 183, 184, 185, 186, 187, 188, 189, 190, 191, 192, 193, 194, 195, 196, 197, 198, 199, 200, 201, 202, 203, 204, 205, 206, 207, 208, 209, 210, 211, 212, 213, 214, 215, 216, 217, 218, 219, 220, 221, 222, 223, 224, 225, 226, 227, 228, 229, 230, 231, 232, 233, 234, 235, 236, 237, 238, 239, 240, 241, 242, 243, 244, 245, 246, 247, 248, 249 or 250 nucleotides.

Once the contents of the cells are released into their respective droplets, the macromolecular components (e.g., macromolecular constituents of biological particles, such as RNA, DNA, or proteins) contained therein may be further processed within the droplets.

As described above, the macromolecular components (e.g., bioanalytes) of individual biological particles (e.g., cells or nuclei) can be provided with unique identifiers (e.g., barcodes) such that upon characterization of those macromolecular components, at which point components from a heterogeneous population of biological particles (e.g., cells or nuclei) may have been mixed and are interspersed or solubilized in a common liquid, any given component (e.g., bioanalyte) may be traced to the biological particle (e.g., cell or nucleus) from which it was obtained. The ability to attribute characteristics to individual biological particles or groups of biological particles is provided by the assignment of unique identifiers specifically to an individual biological particle or groups of biological particles. Unique identifiers, for example, in the form of nucleic acid barcodes, can be assigned or associated with individual biological particles (e.g., cells or nuclei) or populations of biological particles (e.g., cells or nuclei), in order to tag or label the biological particle's macromolecular components (and as a result, its characteristics) with the unique identifiers. These unique identifiers can then be used to attribute the biological particle's components and characteristics to an individual biological particle or group of biological particles. This can be performed by forming droplets including the individual biological particle or groups of biological particles with the unique identifiers (via particles, e.g., beads), as described in the systems and methods herein.

The present invention provides for the use of molecular labels with biological particles (e.g., cells or nuclei or organelles of cells including nuclei). The molecular labels may comprise barcodes (e.g., nucleic acid barcodes). The molecular labels can be provided to the biological particles based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with a biological particle. In the case of a cell, the lipophilic moiety may insert into the plasma membrane of a cell thereby labeling the cell with the barcode. The methods of the present invention may result in molecular labels being present on (i) the interior of a cell or organelle of a cell and/or (ii) the exterior of a cell or organelle of a cell (e.g., on or within the cell membrane). These and other suitable methods will be appreciated by those skilled in the art (see U.S. Published Patent App. Nos. 2019-0177800, 2019-0323088 and 2019-0338353 and U.S. patent application Ser. No. 16/439,675, each of which is incorporated herein by reference in its entirety).

In some aspects, the unique identifiers are provided in the form of oligonucleotides that comprise nucleic acid barcode sequences that may be attached to or otherwise associated with the nucleic acid contents of individual biological particle, or to other components of the biological particle, and particularly to fragments of those nucleic acids. The oligonucleotides are partitioned such that as between oligonucleotides in a given droplet, the nucleic acid barcode sequences contained therein are the same, but as between different droplets, the oligonucleotides can, and do have differing barcode sequences, or at least represent a large number of different barcode sequences across all of the droplets in a given analysis. In some aspects, only one nucleic acid barcode sequence can be associated with a given droplet, although in some cases, two or more different barcode sequences may be present.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Analyte moieties (e.g., oligonucleotides) in droplets can also include other functional sequences useful in processing of nucleic acids from biological particles contained in the droplet. These sequences include, for example, targeted or random/universal amplification primer sequences for amplifying the genomic DNA from the individual biological particles within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

Other mechanisms of forming droplets containing oligonucleotides may also be employed, including, e.g., coalescence of two or more droplets, where one droplet contains oligonucleotides, or microdispensing of oligonucleotides into droplets, e.g., droplets within microfluidic systems.

In an example, particles (e.g., beads) are provided that each include large numbers of the above described barcoded oligonucleotides releasably attached to the beads, where all of the oligonucleotides attached to a particular bead will include the same nucleic acid barcode sequence, but where a large number of diverse barcode sequences are represented across the population of beads used. In some embodiments, hydrogel beads, e.g., beads having polyacrylamide polymer matrices, are used as a solid support and delivery vehicle for the oligonucleotides into the droplets, as they are capable of carrying large numbers of oligonucleotide molecules and may be configured to release those oligonucleotides upon exposure to a particular stimulus, e.g., as described elsewhere herein. In some cases, the population of beads will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more. Additionally, each bead can be provided with large numbers of oligonucleotide molecules attached. In particular, the number of molecules of oligonucleotides including the barcode sequence on an individual bead can be at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules, or more.

Moreover, when the population of beads are included in droplets, the resulting population of droplets can also include a diverse barcode library that includes at least about 1,000 different barcode sequences, at least about 5,000 different barcode sequences, at least about 10,000 different barcode sequences, at least at least about 50,000 different barcode sequences, at least about 100,000 different barcode sequences, at least about 1,000,000 different barcode sequences, at least about 5,000,000 different barcode sequences, or at least about 10,000,000 different barcode sequences. Additionally, each droplet of the population can include at least about 1,000 oligonucleotide molecules, at least about 5,000 oligonucleotide molecules, at least about 10,000 oligonucleotide molecules, at least about 50,000 oligonucleotide molecules, at least about 100,000 oligonucleotide molecules, at least about 500,000 oligonucleotides, at least about 1,000,000 oligonucleotide molecules, at least about 5,000,000 oligonucleotide molecules, at least about 10,000,000 oligonucleotide molecules, at least about 50,000,000 oligonucleotide molecules, at least about 100,000,000 oligonucleotide molecules, and in some cases at least about 1 billion oligonucleotide molecules.

In some cases, it may be desirable to incorporate multiple different barcodes within a given droplet, either attached to a single particle or multiple particles, e.g., beads, within the droplet. For example, in some cases, mixed, but known barcode sequences set may provide greater assurance of identification in the subsequent processing, for example, by providing a stronger address or attribution of the barcodes to a given droplet, as a duplicate or independent confirmation of the output from a given droplet.

Oligonucleotides may be releasable from the particles (e.g., beads) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature of the particle, e.g., bead, environment will result in cleavage of a linkage or other release of the oligonucleotides form the particles, e.g., beads. In still other cases, a chemical stimulus is used that cleaves a linkage of the oligonucleotides to the beads, or otherwise results in release of the oligonucleotides from the particles, e.g., beads. In one case, such compositions include the polyacrylamide matrices described above for encapsulation of biological particles and may be degraded for release of the attached oligonucleotides through exposure to a reducing agent, such as dithiothreitol (DTT).

The droplets described herein may contain either one or more biological particles (e.g., cells or nuclei), either one or more barcode carrying particles, e.g., beads, or both at least a biological particle and at least a barcode carrying particle, e.g., bead. In some instances, a droplet may be unoccupied and contain neither biological particles nor barcode-carrying particles, e.g., beads. Droplet formation can be controlled to achieve a desired occupancy level of particles, e.g., beads, biological particles, or both, within the droplets that are generated.

### Methods

The methods described herein to generate droplets, e.g., of uniform and predictable sizes, and with high throughput, may be used to greatly increase the efficiency of single cell applications and/or other applications receiving droplet-based input. Such single cell applications and other applications may often be capable of processing a certain range of droplet sizes. The methods may be employed to generate droplets for use as microscale chemical reactors, where the volumes of the chemical reactants are small (˜pLs).

The methods disclosed herein may produce emulsions, generally, i.e., droplet of a dispersed phases in a continuous phase. For example, droplets may include a first liquid, and the other liquid may be a second liquid. The first liquid may be substantially immiscible with the second liquid. In some instances, the first liquid may be an aqueous liquid or may be substantially miscible with water. Droplets produced according to the methods disclosed herein may combine multiple liquids. For example, a droplet may combine a first and third liquids. The first liquid may be substantially miscible with the third liquid. The second liquid may be an oil, as described herein.

A variety of applications require the evaluation of the presence and quantification of different biological particle or organism types within a population of biological particles, including, for example, microbiome analysis and characterization, environmental testing, food safety testing, epidemiological analysis, e.g., in tracing contamination or the like.

The methods described herein may allow for the production of one or more droplets containing a single particle, e.g., bead, and/or single biological particle (e.g., cell or nucleus) with uniform and predictable droplet size. The methods also allow for the production of one or more droplets comprising a single biological particle (e.g., cell or nucleus) and more than one particle, e.g., bead, one or more droplets comprising more than one biological particle (e.g., cell or nucleus) and a single particle, e.g., bead, and/or one or more droplets comprising more than one biological particle (e.g., cell or nucleus) and more than one particle, e.g., beads. The methods may also allow for increased throughput of droplet formation.

In general, droplets are produced by providing a device or system as described herein. The device contains at least a first channel with an inlet and an outlet. In one embodiment, the first channel contains a first liquid, and a reservoir contains a second liquid containing an interface with a fluid (e.g., air). The liquid is transported through the outlet, and the device or system causes relative motion of the outlet and the interface. When the outlet crosses the interface, a droplet of the first liquid in the second liquid is produced. Relative motion of the outlet and interface may be caused by moving the first channel, the reservoir, or the interface (or a combination thereof). For example, an actuator may alter the relative vertical position of the outlet while maintaining the reservoir at a substantially constant vertical position (FIGS. 1 and 3). The actuator may alter the relative vertical position of the reservoir while maintaining the first channel at a substantially constant vertical position (FIG. 8). In yet another embodiment, the actuator may actuate (e.g., vibrate) the interface of the liquid in the reservoir while maintaining the first channel and the reservoir at substantially constant vertical positions (FIG. 9).

In some embodiments, droplets are formed as liquid exits the device while it is vibrating. In these embodiments, liquids are transported through the device and out of the device via the first distal end (FIGS. 12A-17). The first distal end may or may not be submerged in the second liquid during droplet formation. In embodiments, the device includes a non-intersecting channel with a distal end open to the exterior of the device. Second liquid is transported through this channel and coats droplets as they are formed (FIG. 17).

The liquid may be transported through the first channel by any suitable means, such as by gravity, capillary action, or via a pump that supplies a predetermined flow rate. The actuator causes the outlet of the first channel to be sequentially positioned above and below the interface of the liquid (e.g., oil) in the reservoir. Each time the outlet moves above the interface, a droplet is generated.

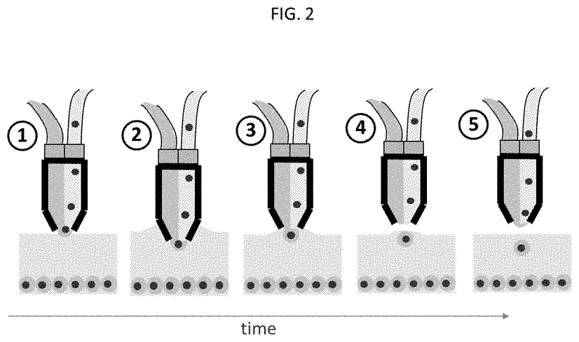

FIG. 2 shows a time course of droplet formation with a device described herein. The device contains a first channel with an outlet and two inlets. Each liquid may be introduced into the first channel via a syringe pump, e.g., supplying a predetermined, constant flow rate. An actuator causes the outlet of the first channel to move above and below the interface of the liquid (e.g., oil) with air in the reservoir. Each time the outlet moves below and above the interface, a droplet is generated. In 1, the outlet of the first channel is above the interface of the liquid in the reservoir, with an amount of liquid beginning to exit the outlet. In 2, the first channel reaches its lowest point in the liquid in the reservoir with a greater amount of liquid at the outlet. In 3, the first channel moves up towards the interface of the liquid in the reservoir with the nascent droplet attached to the outlet. In 4, the first channel continues to move up relative to the interface of the liquid in the reservoir, and the droplet at the outlet of the first channel is detached. In 5, the newly formed droplet sinks to the bottom of the reservoir.

The actuator may have a specified frequency. For example, the actuator may move at about 0.1 Hz, about 0.2 Hz, about 0.3 Hz, about 0.4 Hz, about 0.5 Hz, about 1.0 Hz, about 2.0 Hz, about 3.0 Hz, about 4.0 Hz, about 5.0 Hz, about 6.0 Hz, about 7.0 Hz, about 8.0 Hz, about 9.0 Hz, about 10.0 Hz, about 15 Hz, about 20 Hz, about 30 Hz, about 40 Hz, about 50 Hz, about 60 Hz, about 70 Hz, about 80 Hz, about 90 Hz, about 100 Hz, about 200 Hz, about 300 Hz, about 400 Hz, about 500 Hz, about 600 Hz, about 700 Hz, about 800 Hz, about 900 Hz, about 1,000 Hz, about 2,000 Hz, about 3,000 Hz, about 4,000 Hz, about 5,000 Hz, about 6,000 Hz, about 7,000 Hz, about 8,000 Hz, about 9,000 Hz, or about 10,000 Hz, or faster, e.g., about 1-20 kHz, about 1-10 kHz, or about 2-8 kHz. The frequency of the actuator may be maintained, e.g., at a substantially constant frequency, during a period of droplet formation, or the frequency may be configured to change, e.g., increase or decrease, in response to a feedback stimulus.

The vertical level of the liquid in the reservoir may increase during droplet formation. A sensor (e.g., optical sensor) may be used to sense the vertical position of the level of the liquid in the reservoir. This sensor may provide feedback to the actuator, e.g., to calibrate the vertical position of the actuator (FIG. 3). In embodiments in which the reservoir includes a shunt, the shunt may maintain a substantially constant volume of liquid in the reservoir or a substantially constant vertical position of the interface by allowing liquid to flow out of the reservoir (FIG. 10).

The droplets may contain an aqueous liquid dispersed phase within a non-aqueous continuous phase, such as an oil phase. The droplets can be collected in a substantially stationary volume of liquid, e.g., with the buoyancy of the formed droplets moving them out of the path of nascent droplets (up or down depending on the relative density of the droplets and continuous phase). Alternatively, or in addition, the formed droplets can be moved out of the path of nascent droplets actively, e.g., using a gentle flow of the continuous phase, e.g., a liquid stream or gently stirred liquid.

In embodiments, droplets are collected in reservoirs with moving second liquid. For example, the reservoir may include or be in fluid communication with a trough with an inlet and an outlet. Second liquid flowing through the trough is used to move droplets from the point of contact (FIGS. 12A and 14B). Troughs may or may not be rectangular or sloped. In one embodiment, the trough is shaped, e.g., conically, to allow rotational movement. Collection may also employ a plate that is moved, e.g., rotated or oscillated, to move droplets from the point of contact (FIG. 13). Second liquid in a reservoir may also be moved, e.g., rotated, to move droplets from the point of contact, e.g., to collect at the edge of the plate. For example, the second fluid may be rotated, e.g., by rotating the reservoir or stirring the second liquid, to produce a vortex (FIG. 14A).

Each outlet may interact with the same reservoir, or each outlet may have its own corresponding reservoir. In other embodiments, a subset of the plurality of outlets interacts with a single reservoir. For example, a device has four channels in which two outlets interact with one reservoir and two outlets interact with a second reservoir.

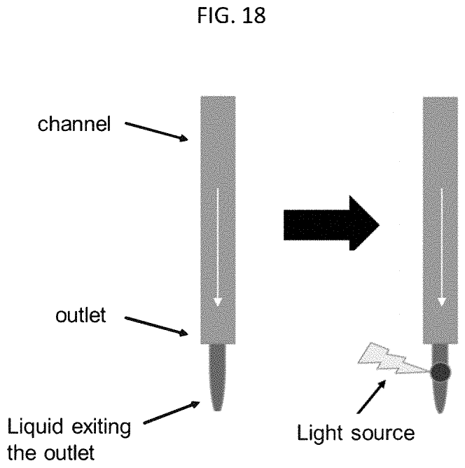

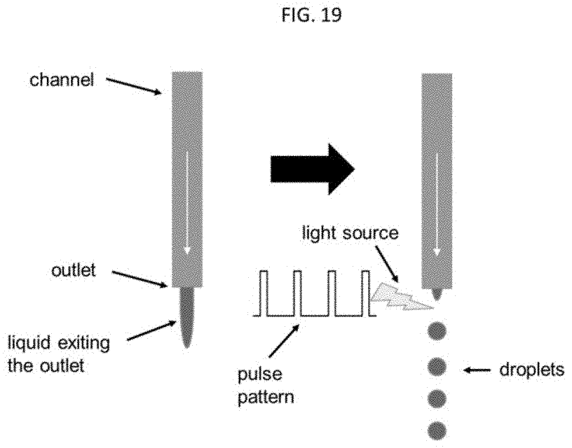

In some embodiments, liquid is transported through the outlet, and a source of electromagnetic energy illuminates the liquid to cause local heating and evaporation to produce a droplet (FIGS. 18-19). In some embodiments, the liquid contains a light-absorbing material (e.g., organic dyes, inorganic pigments, nanoparticles, or quantum dots) that absorbs the energy and produces heat. The light source may deliver pulsed illumination (FIG. 19). In another embodiment, the energy can be guided to propagate within the device by a light guide, e.g., a cladding surrounding a first channel (FIG. 20).

In some embodiments, the liquid flowing in the first channel has a flow velocity from about 0.01 m/s and about 10 m/s (e.g., from about 0.01 m/s to about 0.1 m/s, e.g., about 0.02 m/s, about 0.03 m/s, about 0.04 m/s, about 0.05 m/s, about 0.06 m/s, about 0.07 m/s, about 0.08 m/s, about 0.09 m/s, or about 0.1 m/s), or (e.g., from about 0.1 m/s to about 1.0 m/s, e.g., about 0.2 m/s, about 0.3 m/s, about 0.4 m/s, about 0.5 m/s, about 0.6 m/s, about 0.7 m/s, about 0.8 m/s, about 0.9 m/s, or about 1.0 m/s), or (e.g., from about 1.0 m/s to about 10.0 m/s, e.g., about 1.5 m/s, about 2.0 m/s, about 2.5 m/s, about 3.0 m/s, about 3.5 m/s, about 4.0 m/s, about 4.5 m/s, about 5.0 m/s, about 5.5 m/s, about 6.0 m/s, about 6.5 m/s, about 7.0 m/s, about 7.5 m/s, about 8.0 m/s, about 8.5 m/s, about 9.0 m/s, about 9.5 m/s, or about 10.0 m/s).

Allocating particles, e.g., beads (e.g., microcapsules carrying barcoded oligonucleotides) or biological particles (e.g., cells or nuclei) to discrete droplets may be accomplished by forming droplets, as described herein, from a flowing stream of particles, e.g., beads, in a liquid, e.g., aqueous. In some instances, the occupancy of the resulting droplets (e.g., number of particles, e.g., beads, per droplet) can be controlled by providing the liquid stream at a certain concentration or frequency of particles, e.g., beads. In some instances, the occupancy of the resulting droplets can also be controlled by adjusting one or more geometric features at the outlet, such as a width of a fluidic channel carrying the particles, e.g., beads, relative to a diameter of a given particles, e.g., beads.

Where single particle-, e.g., bead-, containing droplets are desired, the relative flow rates of the liquids can be selected such that, on average, the droplets contain fewer than one particle, e.g., bead, per droplet in order to ensure that those droplets that are occupied are primarily singly occupied. In some embodiments, the relative flow rates of the liquids can be selected such that a majority of (e.g., at least 50%, 60%, 70%, 80%, 90%, 95%, 97%, 99%, or substantially all) droplets are occupied, for example, allowing for only a small percentage of unoccupied droplets. The flows and channel architectures can be controlled as to ensure a desired number of singly occupied droplets, less than a certain level of unoccupied droplets and/or less than a certain level of multiply occupied droplets.

The methods described herein can be operated such that a majority of occupied droplets include no more than one particle of a given type per occupied droplet. In some cases, the droplet formation process is conducted such that fewer than 25% of the occupied droplets contain more than one particle of a given type, and in many cases, fewer than 20% of the occupied droplets have more than one particle of a given type. In some cases, fewer than 10% or even fewer than 5% of the occupied droplets include more than one particle of a given type per droplet.

It may be desirable to avoid the creation of excessive numbers of empty droplets, for example, from a cost perspective and/or efficiency perspective. However, while this may be accomplished by providing sufficient numbers of particles, e.g., beads, into the first channel, the Poisson distribution may expectedly increase the number of droplets that may include multiple biological particles. As such, at most about 95%, 90%, 85%, 80%, 75%, 70%, 65%, 60%, 55%, 50%, 45%, 40%, 35%, 30%, 25%, 20%, 15%, 10%, 5% or less of the generated droplets can be unoccupied. In some cases, the flow of one or more of the particles, or liquids directed into the first channel can be conducted such that, in many cases, no more than about 50% of the generated droplets, no more than about 25% of the generated droplets, or no more than about 10% of the generated droplets are unoccupied. These flows can be controlled so as to present non-Poisson distribution of singly occupied droplets while providing lower levels of unoccupied droplets. The above noted ranges of unoccupied droplets can be achieved while still providing any of the single occupancy rates described above. For example, in many cases, the use of the systems and methods described herein creates resulting droplets that have multiple occupancy rates of less than about 25%, less than about 20%, less than about 15%, less than about 10%, and in many cases, less than about 5%, while having unoccupied droplets of less than about 50%, less than about 40%, less than about 30%, less than about 20%, less than about 10%, less than about 5%, or less.

The flow of the first fluid may be such that the droplets contain a single particle, e.g., bead. In certain embodiments, the yield of droplets containing a single particle is at least 80%, e.g., at least 85%, at least 86%, at least 87%, at least 88%, at least 89%, at least 90%, at least 91%, at least 92%, at least 93%, at least 94%, at least 95%, at least 96%, at least 97%, at least 98%, or at least 99%.

As will be appreciated, the above-described occupancy rates are also applicable to droplets that include both biological particles (e.g., cells or nuclei) and beads. The occupied droplets (e.g., at least about 10%, 20%, 30%, 40%, 50%, 60%, 70%, 80%, 90%, 95%, or 99% of the occupied droplets) can include both a non-biological particle (e.g., a bead) and a biological particle. Particles, e.g., beads, within a channel (e.g., a particle channel) may flow at a substantially regular flow profile (e.g., at a regular flow rate) to provide a droplet, when formed, with a single particle (e.g., bead) and a single cell or other biological particle. Such regular flow profiles may permit the droplets to have a dual occupancy (e.g., droplets having at least one bead and at least one cell or biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%. In some embodiments, the droplets have a 1:1 dual occupancy (i.e., droplets having exactly one particle (e.g., bead) and exactly one cell or biological particle) greater than 5%, 10%, 20%, 30%, 40%, 50%, 60%, 70%, 80%, 81%, 82%, 83%, 84%, 85%, 86%, 87%, 88%, 89%, 90%, 91%, 92%, 93%, 94%, 95%, 96%, 97% 98%, or 99%.

In some cases, additional particles may be used to deliver additional reagents to a droplet. In such cases, it may be advantageous to introduce different particles (e.g., beads) into a common channel (e.g., proximal to or upstream of the outlet) from different bead sources (e.g., containing different associated reagents) through different channel inlets into such common channel. In such cases, the flow and/or frequency of each of the different particle, e.g., bead, sources into the channel or fluidic connections may be controlled to provide for the desired ratio of particles, e.g., beads, from each source, while optionally ensuring the desired pairing or combination of such particles, e.g., beads, are formed into a droplet with the desired number of biological particles.

The droplets described herein may comprise small volumes, for example, less than about 10 microliters (μL), 5 μL, 1 μL, 900 picoliters (pL), 800 pL, 700 pL, 600 pL, 500 pL, 400 pL, 300 pL, 200 pL, 100 pL, 50 pL, 20 pL, 10 pL, 1 pL, 500 nanoliters (nL), 100 nL, 50 nL, or less. For example, the droplets may have overall volumes that are less than about 1000 pL, 900 pL, 800 pL, 700 pL, 600 pL, 500 pL, 400 pL, 300 pL, 200 pL, 100 pL, 50 pL, 20 pL, 10 pL, 1 pL, or less. Where the droplets further comprise particles (e.g., beads or microcapsules), it will be appreciated that the sample liquid volume within the droplets may be less than about 90% of the above described volumes, less than about 80%, less than about 70%, less than about 60%, less than about 50%, less than about 40%, less than about 30%, less than about 20%, or less than about 10% the above described volumes (e.g., of a partitioning liquid), e.g., from 1% to 99%, from 5% to 95%, from 10% to 90%, from 20% to 80%, from 30% to 70%, or from 40% to 60%, e.g., from 1% to 5%, 5% to 10%, 10% to 15%, 15% to 20%, 20% to 25%, 25% to 30%, 30% to 35%, 35% to 40%, 40% to 45%, 45% to 50%, 50% to 55%, 55% to 60%, 60% to 65%, 65% to 70%, 70% to 75%, 75% to 80%, 80% to 85%, 85% to 90%, 90% to 95%, or 95% to 100% of the above described volumes.

Any suitable number of droplets can be generated. For example, in a method described herein, a plurality of droplets may be generated that comprises at least about 1,000 droplets, at least about 5,000 droplets, at least about 10,000 droplets, at least about 50,000 droplets, at least about 100,000 droplets, at least about 500,000 droplets, at least about 1,000,000 droplets, at least about 5,000,000 droplets at least about 10,000,000 droplets, at least about 50,000,000 droplets, at least about 100,000,000 droplets, at least about 500,000,000 droplets, at least about 1,000,000,000 droplets, or more. Moreover, the plurality of droplets may comprise both unoccupied droplets (e.g., empty droplets) and occupied droplets (e.g., droplets containing a single particle, such as a non-biological particle, a biological particle, or a combination thereof).

The fluid to be dispersed into droplets may be transported from a reservoir to the outlet. Alternatively, the fluid to be dispersed into droplets is formed in situ by combining two or more fluids in the device. For example, the fluid to be dispersed may be formed by combining one fluid containing one or more reagents with one or more other fluids containing one or more reagents. In these embodiments, the mixing of the fluid streams may result in a chemical reaction. For example, when a particle is employed, a fluid having reagents that disintegrates the particle may be combined with the particle, e.g., immediately upstream of the outlet. In these embodiments, the particles may be biological particles (e.g., cells or nuclei), which can be combined with lysing reagents, such as surfactants. When particles, e.g., beads, are employed, the particles, e.g., beads, may be dissolved or chemically degraded, e.g., by a change in pH (acid or base), redox potential (e.g., addition of an oxidizing or reducing agent), enzymatic activity, change in salt or ion concentration, or other mechanism.

A fluid (e.g., the first fluid) is transported through the first channel at a flow rate sufficient to produce droplets at the outlet. Faster flow rates of the fluid generally increase the rate of droplet production; however, at a high enough rate, the fluid will form a jet, which may not break up into droplets. Typically, the flow rate of the fluid though the first channel may be from about 0.01 μL/min to about 100 μL/min, e.g., 0.1 to 50 μL/min, 0.1 to 10 μL/min, or 1 to 5 μL/min. In some instances, the flow rate of the fluid may be from about 0.04 μL/min to about 40 μL/min. In some instances, the flow rate of the fluid may be from about 0.01 μL/min to about 100 μL/min. Alternatively, the flow rate of the fluid may be less than about 0.01 μL/min. Alternatively, the flow rate of the fluid may be greater than about 40 μL/min, e.g., about 45 μL/min, about 50 μL/min, about 55 μL/min, about 60 μL/min, about 65 μL/min, about 70 μL/min, about 75 μL/min, about 80 μL/min, about 85 μL/min, about 90 μL/min, about 95 μL/min, about 100 μL/min, about 110 μL/min, about 120 μL/min, about 130 μL/min, about 140 μL/min, about 150 μL/min, or greater. At lower flow rates, such as flow rates of about less than or equal to 10 μL/min, the droplet radius may not be dependent on the flow rate of fluid. Alternatively, or in addition, for any of the abovementioned flow rates, the droplet radius may be independent of the flow rate of the fluid. In some embodiments, fluid flow rates may be synchronized to an illumination frequency for droplet generation, modification, or detection.

In some embodiments, the droplet formation rate for a single channel in a device of the invention is from about 0.1 Hz to about 10,000 Hz, e.g., from about 1 Hz to about 1000 Hz or about 1 Hz to about 500 Hz. The use of multiple channels (e.g., multiple first channels) or multiple outlets can increase the rate of droplet formation by increasing the number of locations of formation.

In some embodiments, the typical droplet formation rate for a single channel in a device of the invention is from about 0.1 Hz to about 1,000,000 Hz (e.g., from about 0.1 Hz to about 1.0 Hz, e.g., about 0.2 Hz, about 0.3 Hz, about 0.4 Hz, about 0.5 Hz, about 0.6 Hz, about 0.7 Hz, about 0.8 Hz, about 0.9 Hz, or about 1.0 Hz), or (e.g., from about 1.0 Hz to about 10 Hz, e.g., about 1.5 Hz, about 2.0 Hz, about 2.5 Hz, about 3.0 Hz, about 3.5 Hz, about 4.0 Hz, about 4.5 Hz, about 5.0 Hz, about 5.5 Hz, about 6.0 Hz, about 6.5 Hz, about 7.0 Hz, about 7.5 Hz, about 8.0 Hz, about 8.5 Hz, about 9.0 Hz, about 9.5 Hz, or about 10 Hz), or (e.g., from about 10 Hz to about 100 Hz, e.g., about 15 Hz, about 20 Hz, about 25 Hz, about 30 Hz, about 35 Hz, about 40 Hz, about 45 Hz, about 50 Hz, about 55 Hz, about 60 Hz, about 65 Hz, about 70 Hz, about 75 Hz, about 80 Hz, about 85 Hz, about 90 Hz, about 95 Hz, or about 100 Hz), or (e.g., from about 100 Hz to about 1,000 Hz, e.g., about 150 Hz, about 200 Hz, about 250 Hz, about 300 Hz, about 350 Hz, about 400 Hz, about 450 Hz, about 500 Hz, about 550 Hz, about 600 Hz, about 650 Hz, about 700 Hz, about 750 Hz, about 800 Hz, about 850 Hz, about 900 Hz, about 950 Hz, or about 1,000 Hz), or (e.g., from about 1,000 Hz to about 10,000 Hz, e.g., about 1,500 Hz, about 2,000 Hz, about 2,500 Hz, about 3,000 Hz, about 3,500 Hz, about 4,000 Hz, about 4,500 Hz, about 5,000 Hz, about 5,500 Hz, about 6,000 Hz, about 6,500 Hz, about 7,000 Hz, about 7,500 Hz, about 8,000 Hz, about 8,500 Hz, about 9,000 Hz, about 9,500 Hz, or about 10,000 Hz), (e.g., from about 10,000 Hz to about 100,000 Hz, e.g., about 15,000 Hz, about 20,000 Hz, about 25,000 Hz, about 30,000 Hz, about 35,000 Hz, about 40,000 Hz, about 45,000 Hz, about 50,000 Hz, about 55,000 Hz, about 60,000 Hz, about 65,000 Hz, about 70,000 Hz, about 75,000 Hz, about 80,000 Hz, about 85,000 Hz, about 90,000 Hz, about 95,000 Hz, or about 100,000 Hz), or (e.g., from about 100,000 Hz to about 1,000,000 Hz, e.g., about 150,000 Hz, about 200,000 Hz, about 250,000 Hz, about 300,000 Hz, about 350,000 Hz, about 400,000 Hz, about 450,000 Hz, about 500,000 Hz, about 550,000 Hz, about 600,000 Hz, about 650,000 Hz, about 700,000 Hz, about 750,000 Hz, about 800,000 Hz, about 850,000 Hz, about 900,000 Hz, about 950,000 Hz, or about 1,000,000 Hz). The use of multiple channels, or multiple outlets, with corresponding light sources, can increase the rate of droplet formation by increasing the number of locations of formation.

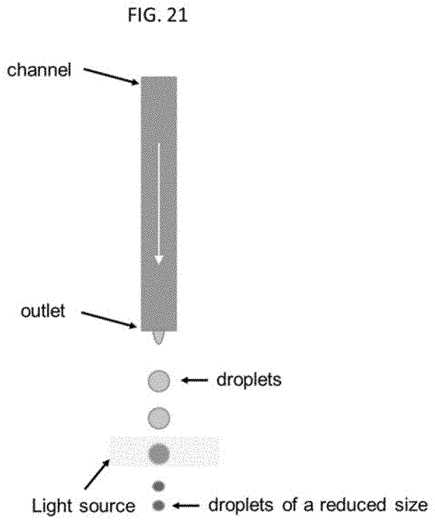

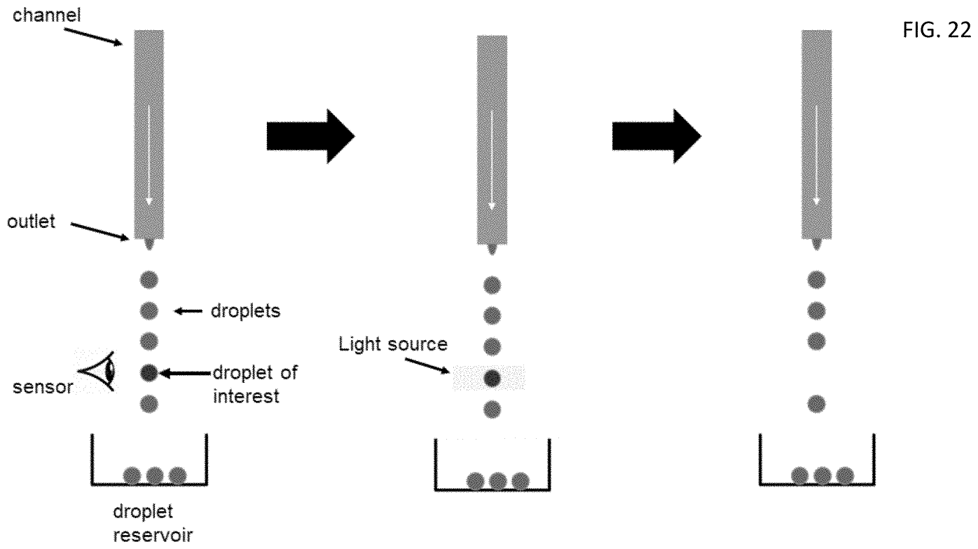

Methods of the present disclosure may be used to reduce the size and/or volume of at least one liquid droplet using electromagnetic energy. Devices or systems can also include at least one sensor to detect one or more droplets of interest. In some embodiments, the one or more droplets of interest are to be reduced in size, e.g., for removal. For example, a droplet not containing a desired particle may be eliminated. A source of electromagnetic energy may irradiate the one or more droplets of interest with sufficient energy density to evaporate at least a portion of the liquid (e.g., by about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or even 100% of its original volume) to reduce the droplet size (FIG. 21). In some embodiments, the size of a droplet is reduced sufficiently that the liquid is completely evaporated and eliminated from the plurality of droplets (FIG. 22). As will be understood, residual solids dissolved or suspended in the liquid may remain. Alternatively, methods of the present disclosure may be used to increase the solute concentration in a droplet by reducing the liquid volume as described.

The methods may be used to produce droplets in range of 1 μm to 500 μm in diameter, e.g., 1 to 250 μm, 5 to 200 μm, 5 to 150 μm, or 12 to 125 μm. Factors that affect the size of the droplets include the rate of formation, the cross-sectional dimension of the distal end of the first channel, e.g., the outlet, and fluid properties and dynamic effects, such as the interfacial tension, viscosity, and flow rate.

The first liquid may be aqueous, and the second liquid may be an oil (or vice versa). Examples of oils include perfluorinated oils, mineral oil, and silicone oils. For example, a fluorinated oil may include a fluorosurfactant for stabilizing the resulting droplets, for example, inhibiting subsequent coalescence of the resulting droplets. Examples of particularly useful liquids and fluorosurfactants are described, for example, in U.S. Pat. No. 9,012,390, which is entirely incorporated herein by reference for all purposes. Specific examples include hydrofluoroethers, such as HFE 7500, 7300, 7200, or 7100. Suitable liquids are those described in US Publication No. 2015/0224466 and U.S. Application No. 62/522,292, the liquids of which are hereby incorporated by reference. In some cases, liquids include additional components such as a particle, e.g., a cell or a gel bead. As discussed above, the first fluid or continuous phase may include reagents for carrying out various reactions, such as nucleic acid amplification, lysis, or bead dissolution. In some embodiments, the liquid (e.g., the first liquid) or continuous phase may include additional components that stabilize or otherwise affect the droplets or a component inside the droplet. Such additional components include surfactants, antioxidants, preservatives, buffering agents, antibiotic agents, salts, chaotropic agents, enzymes, nanoparticles, and sugars. The first liquid may also include reagents that absorb electromagnetic energy.

Devices, systems, compositions, and methods of the present disclosure may be used for various applications, such as, for example, processing a single analyte (e.g., bioanalytes, e.g., RNA, DNA, or protein) or multiple analytes (e.g., bioanalytes, e.g., DNA and RNA, DNA and protein, RNA and protein, or RNA, DNA and protein) from a single cell. For example, a biological particle (e.g., a cell or virus) can be formed in a droplet, and one or more analytes (e.g., bioanalytes) from the biological particle (e.g., cell or nucleus) can be modified or detected (e.g., bound, labeled, or otherwise modified by an analyte moiety) for subsequent processing. The multiple analytes may be from the single cell. This process may allow, for example, proteomic, transcriptomic, and/or genomic analysis of the cell or population thereof (e.g., simultaneous proteomic, transcriptomic, and/or genomic analysis of the cell or population thereof).

Methods of modifying analytes include providing a plurality of particles (e.g., beads) in a liquid carrier (e.g., an aqueous carrier); providing a sample containing an analyte (e.g., as part of a cell, or component or product thereof) in a sample liquid; and using the device to combine the liquids and form an analyte droplet containing one or more particles and one or more analytes (e.g., as part of one or more cells, or components or products thereof). Such sequestration of one or more particles with analyte (e.g., bioanalyte associated with a cell) in a droplet allows labeling of discrete portions of large, heterologous samples (e.g., single cells within a heterologous population). Once labeled or otherwise modified, droplets can be combined (e.g., by breaking an emulsion), and the resulting liquid can be analyzed to determine a variety of properties associated with each of numerous single cells.

In particular embodiments, the invention features methods of producing analyte droplets using a device having a particle channel and a sample channel that intersect upstream of the outlet. Particles having an analyte moiety in a liquid carrier flow proximal-to-distal (e.g., towards the outlet) through the particle channel and a sample liquid containing an analyte flows proximal-to-distal (e.g., towards the outlet) through the sample channel until the two liquids meet and combine at the intersection of the sample channel and the particle channel, upstream (and/or proximal to) the outlet. The combination of the liquid carrier with the sample liquid results in an analyte liquid. In some embodiments, the two liquids are miscible (e.g., they both contain solutes in water or aqueous buffer). The combination of the two liquids can occur at a controlled relative rate, such that the analyte liquid has a desired volumetric ratio of particle liquid to sample liquid, a desired numeric ratio of particles to biological particles (e.g., cells or nuclei), or a combination thereof (e.g., one particle per cell per 50 pL). As the analyte liquid flows through the outlet into a partitioning liquid (e.g., a liquid which is immiscible with the analyte liquid, such as an oil), analyte droplets form. Alternatively, or in addition, the analyte droplets may accumulate (e.g., as a substantially stationary population) in the reservoir. In some cases, the accumulation of a population of droplets may occur by a gentle flow of a fluid within the reservoir, e.g., to move the formed droplets out of the path of the nascent droplets.

A device useful for droplet formation, e.g., analyte, may feature multiple outlets (e.g., in or out of (e.g., as independent, parallel circuits) fluid communication with one another. For example, such a device may have 2-100, 3-50, 4-40, 5-30, 6-24, 8-18, or 9-12, e.g., 2-6, 6-12, 12-18, 18-24, 24-36, 36-48, or 48-96, e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, or more outlets configured to produce analyte droplets). In this context, a device as described herein may include a plurality of channels, each channel containing an outlet. Each channel may contact an interface of a liquid in the reservoir. Each outlet may interact with the same reservoir, or each outlet may have its own corresponding reservoir. In other embodiments, each subset of the plurality of outlets interacts with a corresponding reservoir. For example, a device with four channels in which a first subset of two channels with two outlets interacts with one reservoir, and a second subset of two channels with two outlets interacts with a second reservoir.

Source reservoirs can store liquids prior to and during droplet formation. In some embodiments, a device useful in analyte droplet formation includes one or more particle reservoirs connected proximally to one or more particle channels. Particle suspensions can be stored in particle reservoirs prior to analyte droplet formation. Particle reservoirs can be configured to store particles containing an analyte moiety. For example, particle reservoirs can include, e.g., a coating to prevent adsorption or binding (e.g., specific or non-specific binding) of particles or analyte moieties. Additionally, or alternatively, particle reservoirs can be configured to minimize degradation of analyte moieties (e.g., by containing nuclease, e.g., DNAse or RNAse) or the particle matrix itself, accordingly.

Additionally, or alternatively, a device includes one or more sample reservoirs connected proximally to one or more sample channels. Samples containing biological particles (e.g., cells or nuclei) and/or other reagents useful in analyte and/or droplet formation can be stored in sample reservoirs prior to analyte droplet formation. Sample reservoirs can be configured to reduce degradation of sample components, e.g., by including nuclease (e.g., DNAse or RNAse).

Methods of the invention include administering a sample and/or particles to the device, for example, (a) by pipetting a sample liquid, or a component or concentrate thereof, into a sample reservoir and/or (b) by pipetting a liquid carrier (e.g., an aqueous carrier) and/or particles into a particle reservoir. In some embodiments, the method involves first pipetting the liquid carrier (e.g., an aqueous carrier) and/or particles into the particle reservoir prior to pipetting the sample liquid, or a component or concentrate thereof, into the sample reservoir.

The sample reservoir and/or particle reservoir may be incubated in conditions suitable to preserve or promote activity of their contents until the initiation or commencement of droplet formation.

Formation of bioanalyte droplets, as provided herein, can be used for various applications. In particular, by forming bioanalyte droplets using the methods, devices, systems, and kits herein, a user can perform standard downstream processing methods to barcode heterogeneous populations of biological particles (e.g., cells or nuclei) or perform single-cell nucleic acid sequencing.

In methods of barcoding a population of biological particles (e.g., cells or nuclei), an aqueous sample having a population of biological particles (e.g., cells or nuclei) is combined with bioanalyte particles having a nucleic acid primer sequence and a barcode in an aqueous carrier at an intersection of the sample channel and the particle channel to form a reaction liquid. Upon passing through the outlet, the reaction liquid meets a partitioning liquid (e.g., a partitioning oil) under droplet-forming conditions to form a plurality of reaction droplets, each reaction droplet having one or more of the particles and one or more biological particles (e.g., cells or nuclei) in the reaction liquid. The reaction droplets are incubated under conditions sufficient to allow for barcoding of the nucleic acid of the biological particles (e.g., cells or nuclei) in the reaction droplets. In some embodiments, the conditions sufficient for barcoding are thermally optimized for nucleic acid replication, transcription, and/or amplification. For example, reaction droplets can be incubated at temperatures configured to allow reverse transcription of RNA produced by a cell in a droplet into DNA, using reverse transcriptase. Additionally, or alternatively, reaction droplets may be cycled through a series of temperatures to promote amplification, e.g., as in a polymerase chain reaction (PCR). Accordingly, in some embodiments, one or more nucleotide amplification reagents (e.g., PCR reagents) are included in the reaction droplets (e.g., primers, nucleotides, and/or polymerase). Any one or more reagents for nucleic acid replication, transcription, and/or amplification can be provided to the reaction droplet by the aqueous sample, the liquid carrier, or both. In some embodiments, one or more of the reagents for nucleic acid replication, transcription, and/or amplification are in the aqueous sample.

Also provided herein are methods of single-cell nucleic acid sequencing, in which a heterologous population of biological particles (e.g., cells or nuclei) can be characterized by their individual gene expression, e.g., relative to other biological particles (e.g., cells or nuclei) of the population. Methods of barcoding biological particles (e.g., cells or nuclei) discussed above and known in the art can be part of the methods of single-cell nucleic acid sequencing provided herein. After barcoding, nucleic acid transcripts that have been barcoded are sequenced, and sequences can be processed, analyzed, and stored according to known methods. In some embodiments, these methods enable the generation of a genome library containing gene expression data for any single cell within a heterologous population.

Alternatively, the ability to sequester a single cell in a reaction droplet provided by methods herein allows for applications beyond genome characterization. For example, a reaction droplet containing a single cell and variety of analyte moieties capable of binding different proteins can allow a single cell to be detectably labeled to provide relative protein expression data. In some embodiments, analyte moieties are antigen-binding molecules (e.g., antibodies or fragments thereof), wherein each antibody clone is detectably labeled (e.g., with a fluorescent marker having a distinct emission wavelength). Binding of antibodies to proteins can occur within the reaction droplet, and biological particles (e.g., cells or nuclei) can be subsequently analyzed for bound antibodies according to known methods to generate a library of protein expression. Other methods known in the art can be employed to characterize biological particles (e.g., cells or nuclei) within heterologous populations after detecting analytes using the methods provided herein. In one example, following the formation or droplets, subsequent operations that can be performed can include formation of amplification products, purification (e.g., via solid phase reversible immobilization (SPRI)), further processing (e.g., shearing, ligation of functional sequences, and subsequent amplification (e.g., via PCR)). These operations may occur in bulk (e.g., outside the droplet). An exemplary use for droplets formed using methods of the invention is in performing nucleic acid amplification, e.g., polymerase chain reaction (PCR), where the reagents necessary to carry out the amplification are contained within the first fluid. In the case where a droplet is a droplet in an emulsion, the emulsion can be broken and the contents of the droplet pooled for additional operations. Additional reagents that may be included in a droplet along with the barcode bearing bead may include oligonucleotides to block ribosomal RNA (rRNA) and nucleases to digest genomic DNA from biological particles (e.g., cells or nuclei). Alternatively, rRNA removal agents may be applied during additional processing operations. The configuration of the constructs generated by such a method can help minimize (or avoid) sequencing of poly-T sequence during sequencing and/or sequence the 5′ end of a polynucleotide sequence. The amplification products, for example first amplification products and/or second amplification products, may be subject to sequencing for sequence analysis. In some cases, amplification may be performed using the Partial Hairpin Amplification for Sequencing (PHASE) method.

### Methods of Device Manufacture

The microfluidic devices of the present disclosure may be fabricated in any of a variety of conventional ways. For example, in some cases the devices comprise layered structures, where a first layer includes a planar surface into which is disposed at least a first channel with an outlet. The device may further include series of channels or grooves that correspond to a network of channels that intersect upstream of the outlet in the finished device. A second layer includes a planar surface on one side, and a series of one or more reservoirs defined on the opposing surface, where the reservoirs communicate as passages through to the planar layer, such that when the planar surface of the second layer is mated with the planar surface of the first layer, the one or more reservoirs defined in the second layer are positioned in liquid communication with the termini of the one or more channels on the first layer. Alternatively, the reservoirs and the connected channels may be fabricated into a single part, where the reservoirs are provided upon a first surface of the structure, with the apertures of the reservoirs extending through to the opposing surface of the structure. The channel network is fabricated as a series of grooves and features in this second surface. A thin laminating layer is then provided over the second surface to seal, and provide the final wall of the channel network, and the bottom surface of the reservoirs.

These layered structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof. Polymeric device components may be fabricated using any of a number of processes including soft lithography, embossing techniques, micromachining, e.g., laser machining, or in some aspects, injection molding of the layer components that include the defined channels as well as other structures, e.g., reservoirs, integrated functional components, etc. In some aspects, the structure comprising the reservoirs and channels may be fabricated using, e.g., injection molding techniques to produce polymeric structures. In such cases, a laminating layer may be adhered to the molded structured part through readily available methods, including thermal lamination, solvent based lamination, sonic welding, or the like.

As will be appreciated, structures comprised of inorganic materials also may be fabricated using known techniques. For example, channels and other structures may be micro-machined into surfaces or etched into the surfaces using standard photolithographic techniques. In some aspects, the microfluidic devices or components thereof may be fabricated using three-dimensional printing techniques to fabricate the channel or other structures of the devices and/or their discrete components.

### EXAMPLES

The following examples are put forth so as to provide those of ordinary skill in the art with a description of how the compositions and methods described herein may be used, made, and evaluated, and are intended to be purely exemplary of the invention and are not intended to limit the scope of what the inventors regard as their invention.

### Example 1

FIG. 1 shows an embodiment of a device according to the invention that includes a channel with an outlet. A reservoir contains a second liquid (e.g., continuous phase, e.g., oil) having an interface with a fluid (e.g., air). In this embodiment, the device includes two inlets upstream of the outlet, and each inlet is connected to tubes containing a liquid. One liquid contains particles, and the second liquid does not contain particles. The two liquids mix as they enter the channel. The device is connected to an actuator that causes relative motion between the outlet of the channel and the surface of the liquid in the reservoir. As the liquid is transported through the outlet, the relative motion of the outlet and the interface causes droplets to form. A droplet may be formed each time the outlet passes the interface of the liquid in the reservoir. If the droplets are denser than the liquid in the reservoir, then the droplets sink to the bottom of the reservoir.

### Example 2

FIG. 3 shows an embodiment of a system described herein in which each of two inlets to the channel is connected to a syringe pump, which drives liquid through the channel during droplet generation. The device is connected to an actuator that is positioned on a platform that moves up and down. A liquid level sensor detects the level of the liquid in the reservoir. As droplets are generated and the volume of the liquid in the reservoir increases, the liquid level sensor can provide feedback to the actuator to move the platform and accommodate for the increased volume in the reservoir.

### Example 3

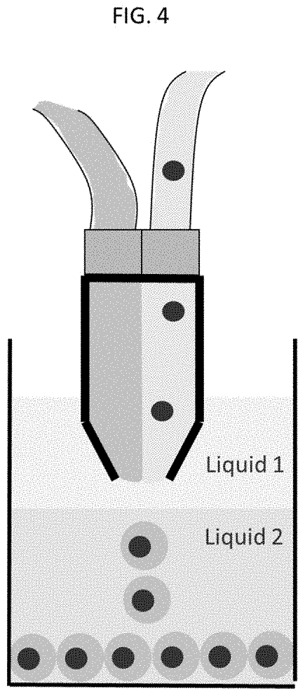

FIG. 4 shows an embodiment of a device as described herein in which the outlet of the channel crosses an interface between two immiscible liquids in the reservoir. At its highest vertical position, the outlet of the channel is within the upper liquid and at its lowest vertical position, the outlet of the channel is within the lower liquid. As the outlet crosses the interface between the two liquids, droplets are generated in the lower liquid. The droplet generation can be modified by adding surfactant molecules at the interface between the upper liquid and the lower liquid.

### Example 4

FIG. 5 shows an embodiment of a device in which two liquids mix at the inlet of the channel. This configuration may allow for a longer mixing time and increasing the stability of the droplets generated.

### Example 5

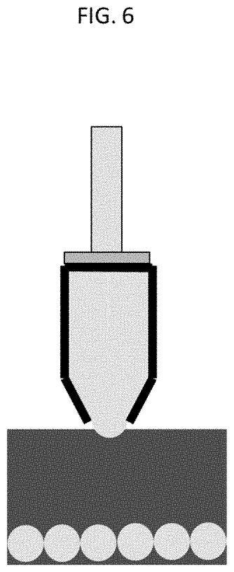

FIG. 6 shows an embodiment of a device in which the oil is the dispersed phase and the aqueous liquid is the continuous phase. As the outlet moves across the interface of the liquid in the reservoir, the devices forms oil in water droplets.

### Example 6

FIG. 7 shows an embodiment of a device in which the dispersed phase is less dense than the continuous phase. This results in droplets rising above the vertical height of the interface as the droplets are generated. The localized meniscus may be used to store the droplets as they are generated.

### Example 7

FIG. 8 shows an embodiment of a device in which the reservoir is connected to an actuator. In this embodiment, the reservoir moves up and down, and the device remains substantially stationary.

### Example 8

FIG. 9 shows an embodiment of a device in which the actuator is an ultrasonic transducer operatively coupled to the liquid in the reservoir. The transducer vibrates the surface of the interface while the device and the reservoir remain substantially stationary. In this embodiment, the transducer may create a high intensity non-uniform field to create a pattern of nodes at the interface. Droplets are formed as the nodes move up and down, and the interface crosses the outlet of the channel.

### Example 9

FIG. 10 shows an embodiment of a device in which the reservoir contains a shunt. The shunt is configured to maintain a predetermined volume of liquid, and therefore, a substantially constant vertical location of the interface as droplets are formed. As more droplets are formed, the liquid at the top of the reservoir will exit the through the shunt. By maintaining a substantially constant vertical location of the interface, the device may not need any adjustment during droplet generation.

### Example 10

FIG. 11 shows an embodiment of a microfluidic device in which the device includes a plurality of channels. In this embodiment, the device includes eight channels, and each channel is configured to produce droplets at the interface. The entire device is connected to an actuator, and each time the outlet of the channels moves across the interface of the liquid in the reservoir, eight droplets are formed. This design provides higher throughput of droplet generation than a single channel. Inset on the right is an optional design feature in which a nozzle is added to the outlet of the channel. The nozzle may be part of the device or a separate feature. The geometry and surface properties of the nozzle may be adjusted to ensure robust droplet generation.

### Example 11

FIG. 12A shows an embodiment of a system in which a microfluidic device produces droplets over a sloped trough. A second fluid (in this case an oil) flows from the inlet to the outlet. The flowing oil moves the incoming droplets away from the point of contact. The rate of flow and droplet formation may be adjusted to maximize droplet generation, minimize deformation of the droplets, and/or improve droplet uniformity.

FIG. 12B are photographs of droplets produced with and without using the trough. Use of the trough results in greater droplet uniformity.

### Example 12

FIG. 13 shows an embodiment of a system in which a microfluidic device produces droplets over a plate. The plate, and the fluid on top of it, moves to move the incoming droplets away from the point of contact. The rate of movement, e.g., rotation, and droplet formation may be adjusted to maximize droplet generation, minimize deformation of the droplets, and/or improve droplet uniformity.

### Example 13

FIG. 14A shows an embodiment of a system in which a microfluidic device produces droplets over a reservoir. The fluid in the reservoir is moved, e.g., rotated, to move the incoming droplets away from the point of contact. The rate of movement, e.g., rotation, and droplet formation may be adjusted to maximize droplet generation, minimize deformation of the droplets, and/or improve droplet uniformity.

FIG. 14B shows an embodiment of a system in which a microfluidic device produces droplets over a cone shaped trough is a reservoir. The liquid in the reservoir moves from the inlet to an outlet, e.g., rotationally, to move the incoming droplets away from the point of contact. The flow rate and droplet formation may be adjusted to maximize droplet generation, minimize deformation of the droplets, and/or improve droplet uniformity.

### Example 14

FIG. 15A shows an embodiment of a system in which a microfluidic device connected to two reservoirs and equipped with a piezoelectric element produces droplets while being vibrated. The droplets produced are formed as they exit the device and are allowed to fall into a third reservoir with oil in which the droplets are immiscible.

FIG. 15B shows an embodiment of a system in which a microfluidic device connected to two reservoirs and equipped with a piezoelectric element produces droplets while being vibrated. The droplets produced are formed as they exit the device into a third reservoir with oil in which the droplets are immiscible. In this embodiment the exit of the device is submerged in the immiscible fluid.

FIG. 15C is a photograph of devices of FIG. 15A and FIG. 15B producing droplets in air and directly in oil.

### Example 15

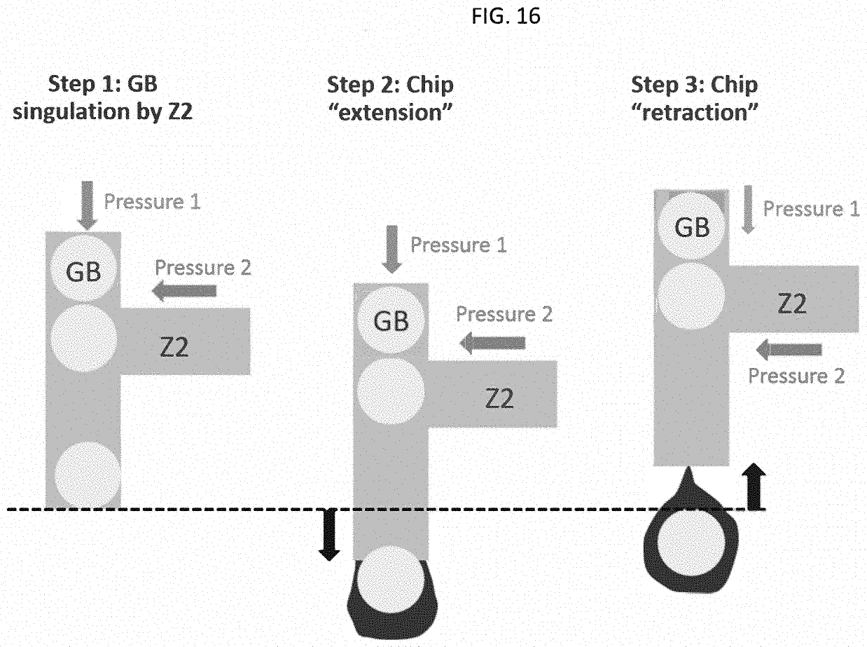

FIG. 16 shows an embodiment of the invention illustrating the method of producing droplets containing a single bead. In step 1, the flow rates of the bead channel and buffer channel are selected to singulate a bead. In step 2, the device is vibrated, and a nascent droplet forms at the outlet of the channel at the exterior of the device. In step 3, movement in the opposite direction releases the droplet from the device.

### Example 16

FIG. 17 shows an embodiment of a system in which a microfluidic device connected to three reservoirs and equipped with a piezoelectric element produces droplets while being vibrated. The microfluidic device combines two of the liquids (depicted as 1 and 2) to form the droplets. As the droplets are formed, they are coated with a liquid, e.g., oil, from a reservoir depicted as 3 with which they are immiscible. The coated droplets are then allowed to fall into a reservoir. In one embodiment, the system may include components to facilitate movement of a coated droplet away from the point of contact, as further described herein.

### Example 17

FIG. 18 shows an embodiment of a device according to the invention that includes a channel with an outlet and a liquid exiting the outlet. As the liquid is transported through the outlet, light from a laser is focused onto the liquid to heat and evaporate the liquid to generate droplets.

### Example 18

FIG. 19 shows an embodiment of a device according to the invention that includes a channel with an outlet and a liquid exiting the outlet. The liquid is transported continuously through the outlet, and light from an LED is focused onto the liquid. The LED light is modulated according to a pulse pattern. The light from the LED heats and evaporates portions of the liquid exiting the outlet generating droplets.

### Example 19

FIG. 20 shows an embodiment of a device according to the invention that includes a channel with an outlet, a liquid exiting the outlet, and a cladding surrounding the channel. The liquid is transported through the outlet. Light from a laser enters the cladding and exits the cladding near the outlet, to be directed onto the liquid exiting the outlet. The light evaporates portions of the liquid exiting the outlet generating droplets.

### Example 20

FIG. 21 shows an embodiment of a device according to the invention that includes a channel with an outlet and a stream of droplets exiting the outlet. Droplets exiting the outlet are transiently illuminated by a light source to partially evaporate the liquid droplets and to generate droplets of a reduced size.

### Example 21

FIG. 22 shows an embodiment of a device according to the invention that includes a channel with an outlet, a stream of liquid droplets, and a droplet reservoir. A droplet of interest is identified by a sensor that activates a light source to illuminate the droplet of interest to evaporate the liquid and remove the droplet of interest.

### OTHER EMBODIMENTS

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

Other embodiments are in the claims.

1. A method of producing droplets, comprising:
(a) providing a device comprising:
i) a first channel having a first proximal end and a first distal end, wherein the first distal end is open to the exterior of the device; and
ii) a second channel having a second proximal end and a second distal end, wherein the first and second channels intersect between the first proximal and first distal ends;
(b) transporting a first liquid from the first proximal end to the intersection and a third liquid from the second proximal end to the intersection to form a combined liquid; and
(c) transporting the combined liquid to the first distal end and vibrating the device to form droplets as the combined liquid exits the device.

2. The method of claim 1, wherein a piezoelectric or acoustic actuator vibrates the device.

3. The method of claim 1, wherein the vibrational amplitude is at most twice the width of the first distal end.

4. The method of claim 3, wherein the vibrational amplitude is about equal to the width of the first distal end.

5. The method of claim 1, wherein the first and third liquids are aqueous or miscible with water.

6. The method of claim 1, wherein the first liquid comprises particles.

7. The method of claim 6, wherein the particles comprise beads or biological particles.

8. The method of claim 1, wherein the third liquid comprises particles.

9. The method of claim 1, wherein the first liquid comprises first particles and the third liquid comprises second particles.

10. The method of claim 9, wherein a portion of the droplets comprises one first and one second particle.

11. The method of claim 10, wherein a portion of the droplets comprises a single first particle and a single second particle.

12. The method of claim 11, wherein one of the first and second particles is beads, and the other is biological particles.

13. The method of claim 1, wherein the device further comprises a third channel with a third proximal end and a third distal end, wherein the first and third channels intersect between the first proximal and first distal ends.

14. The method of claim 13, wherein the second and third channels intersect the first channel in the same location.

15. The method of claim 14, wherein the proximal ends of the second and third channels are connected.

16. The method of claim 1, wherein, prior to step (b), the first and third fluids are passed through the first and second channels at a rate higher than that of step (b).

17. The method of claim 1, wherein the exterior of the device around the first distal end comprises a material that the combined fluid does not wet.

18. The method of claim 1, wherein the first distal end is submerged in a second, immiscible fluid during step (c).

19. The method of claim 1, wherein the device further comprises at least one fourth channel having a proximal end and a distal end, wherein the fourth channel does not intersect the first or second channels and the distal end of the fourth channel is open to the exterior of the device and a second liquid is transported from the proximal to the distal end of the fourth channel, wherein the second liquid contacts the droplets.

20. The method of claim 19, wherein the exterior of the device surrounding the fourth distal end has a material that the second liquid does not wet.

21. A method of producing droplets comprising a non-biological particle, the method comprising:
(a) providing a device comprising a first channel having an outlet and comprising a first liquid comprising non-biological particles and a reservoir comprising a second liquid having an interface with a fluid; and
(b) transporting the first liquid through the outlet and causing relative motion of the outlet and the interface to produce droplets of the first liquid and the non-biological particle in the second liquid.

22. The method of claim 21, wherein the reservoir comprises a shunt configured to maintain a substantially constant vertical location of the interface as droplets are formed.

23. The method of claim 21, wherein step (b) comprises causing the interface to move while the outlet is stationary.

24. The method of claim 23, wherein step (b) comprises moving the reservoir.

25. The method of claim 23, wherein the interface is moved without moving the reservoir.

26. The method of claim 23, wherein step (b) comprises activating an actuator operatively coupled to the second liquid resulting in movement of the interface.

27. The method of claim 21, wherein step (b) comprises causing the outlet to move.

28. The method of claim 21, wherein the device further comprises a second channel that intersects the first channel upstream of the outlet.

29. The method of claim 21, wherein the second channel comprises a third liquid, and the droplets produced comprise the first liquid, the third liquid, and the non-biological particle.

30. The method of claim 29, wherein the third liquid comprises a biological particle.

31. The method of claim 21, wherein the fluid is a fourth liquid immiscible with the second liquid.

32. The method of claim 21, wherein the device comprises a plurality of the first channels, and step (b) comprises transporting the first liquid through the outlet of each of the plurality of first channels and causing relative motion of the outlet of each of the plurality of first channels and the interface.

33. The method of claim 32, wherein the plurality comprises 2, 3, 4, 5, 6, 7, 8, 9, or 10 of the first channels.

34. A system for producing droplets of a first liquid in a second liquid, the system comprising a device comprising a first channel having an outlet and a reservoir comprising a second liquid having an interface with a fluid;
wherein the system is configured to cause relative motion of the outlet with respect to the interface so that the outlet crosses the interface; and
wherein the reservoir comprises a shunt configured to maintain a substantially constant vertical location of the interface as droplets are formed.

35. A system for producing droplets of a first liquid in a second liquid, the system comprising a device comprising a first channel having an outlet, a reservoir comprising a second liquid having an interface with a fluid, and an actuator operatively coupled to the second liquid to move the interface relative to the outlet;
wherein the system is configured to cause relative motion of the outlet with respect to the interface so that the outlet crosses the interface.

36. The system of claim 35, wherein the reservoir comprises a shunt configured to maintain a substantially constant vertical location of the interface as droplets are formed.

37. The system of claim 34 or 35, wherein the device further comprises a second channel that intersects the first channel upstream of the outlet.

38. The system of claim 37, wherein the second channel comprises a third liquid.

39. The system of claim 34 or 35, wherein the fluid is a fourth liquid immiscible with the second liquid.

40. The system of claim 34 or 35, wherein the system comprises a plurality of the first channels.

41. The system of claim 40, wherein the plurality comprises 2, 3, 4, 5, 6, 7, 8, 9, or 10 of the first channels.

42. The system of claim 35, wherein the actuator produces an acoustic or a mechanical wave.

43. The system of claim 34 or 35, further comprising a sensor configured to detect a vertical position of the interface in the second liquid.

44. A method of producing droplets of a first liquid in a second liquid:
(a) providing the system of any one of claims 34-43; and
(b) transporting the first liquid through the outlet and causing relative motion of the outlet and the interface to produce droplets of the first liquid in the second liquid.

45. The method of claim 44, wherein the method produces droplets in which at least 50%, 60%, 70%, 80%, 90%, 95%, 97%, 99%, or 100% of the droplets include exactly one particle.

46. A device for producing droplets, comprising:
i) a first channel having a first proximal end and a first distal end, wherein the first distal end is open to the exterior of the device; and
ii) a second channel having a second proximal end and a second distal end, wherein the first and second channels intersect between the first proximal and first distal ends.

47. The device of claim 46, wherein the device further comprises a vibration source.

48. The device of claim 47, wherein the vibration source is a piezoelectric or acoustic actuator.

49. The device of claim 46, wherein the device further comprises a first reservoir in fluid communication with the first proximal end.

50. The device of claim 49, wherein the device further comprises a second reservoir in fluid communication with the second proximal end.

51. The device of claim 46, wherein the device further comprises a third channel with a third proximal end and a third distal end, wherein the first and third channels intersect between the first proximal and first distal ends.

52. The device of claim 51, wherein the second and third channels intersect the first channel in the same location.

53. The device of claim 52, wherein the proximal ends of the second and third channels are connected.

54. The device of claim 46, wherein the device further comprises at least one fourth channel having a proximal end and a distal end, wherein the fourth channel does not intersect the first or second channels, the distal end of the fourth channel is open to the exterior of the device and positioned to allow liquid passing there through to contact droplets formed at the distal end of the first channel.

55. The device of claim 54, wherein the exterior of the device surrounding the fourth distal end has a material that is hydrophilic or fluorophobic.

56. The device of claim 46, wherein the exterior of the device around the first distal end comprises a material that is hydrophobic.

57. A system for producing droplets comprising
i) a device of claim 46; and
ii) a vibration source operatively coupled to the device.

58. The system of claim 57, further comprising a first liquid in the first channel and a third liquid in the second channel.

59. The system of claim 58, wherein the first liquid comprises first particles and the third liquid comprises second particles.

60. The system of claim 59, wherein one of the first and second particles is beads, and the other is biological particles.

61. The system of claim 57, further comprising a controller operatively coupled to transport the first and thirds liquids to the intersection to form a combined liquid and to transport the combined liquid to the first distal end.

62. The system of claim 57, wherein the vibration source is a piezoelectric or acoustic actuator.

63. The system of claim 57, further comprising a first reservoir in fluid communication with the first proximal end.

64. The system of claim 57, further comprising a second reservoir in fluid communication with the second proximal end.

65. The system of claim 57, further comprising a collection reservoir disposed to collect droplets exiting from the first distal end.

66. The system of claim 65, wherein the collection reservoir comprises a second liquid with which the droplets are immiscible.

67. The system of claim 66, wherein the first distal end submerges in the second liquid.

68. The system of claim 57, wherein the device further comprises a third channel with a third proximal end and a third distal end, wherein the first and third channels intersect between the first proximal and first distal ends.

69. The system of claim 68, wherein the second and third channels intersect the first channel in the same location.

70. The system of claim 68, wherein the proximal ends of the second and third channels are connected.

71. The system of claim 68, wherein the liquid in the third channel is the second liquid or a different liquid.

72. The system of claim 68, wherein the vibration source is operatively connected to the collection reservoir.

73. The system of claim 57, wherein the device further comprises at least one fourth channel having a proximal end and a distal end, wherein the fourth channel does not intersect the first or second channels, the distal end of the fourth channel is open to the exterior of the device and positioned to allow a second liquid passing there through to contact droplets formed at the distal end of the first channel.

74. The system of claim 73, wherein the exterior of the device surrounding the fourth distal end has a material that the second liquid does not wet.

75. The system of claim 58, wherein the exterior of the device around the first distal end comprises a material that the first liquid does not wet.

76. A method of collecting droplets comprising:
a) providing a device comprising a trough having an inlet and an outlet and comprising a second liquid;
b) allowing droplets of a first liquid to enter the trough as the second liquid flows from the inlet to the outlet, wherein the first and second liquids are immiscible with each other.

77. The method of claim 76, wherein the trough has a descending angle from inlet to outlet.

78. The method of claim 77, wherein the angle is from about 1° to about 89°.

79. The method of claim 77, wherein the flow rate of the second liquid is from about 150 μL/min to about 115 L/min.

80. The method of claim 77, wherein the first liquid is less dense than the second liquid.

81. The method of claim 77, wherein the first liquid comprises particles.

82. The method of claim 81, wherein the particles comprise beads or biological particles.

83. A method of collecting droplets comprising:
a) providing a moving plate comprising a second liquid; and
b) allowing droplets of a first liquid to contact the second liquid as the plate moves, wherein the droplets are transported away from the point of contact and the first and second liquids are immiscible with each other.

84. The method of claim 83, wherein the motion of the plate in step (a) is rotational.

85. The method of claim 84, wherein the speed of rotation is from about 0.05 MHz to about 150 MHz.

86. The method of claim 83, wherein the motion of the plate in step (a) is oscillatory.

87. The method of claim 86, wherein the frequency of oscillation is from about 0.05 MHz to about 150 MHz.

88. The method of claim 83, wherein the second liquid is added while the plate is moving.

89. The method of claim 88, wherein the rate of adding second liquid is from about 150 μL/min to about 115 L/min.

90. The method of claim 83, wherein the plate comprises a reservoir containing second liquid.

91. The method of claim 83, wherein the first liquid is less dense than the second liquid.

92. The method of claim 83, wherein the first liquid comprises particles.

93. The method of claim 83, wherein the particles comprise beads or biological particles.

94. A method of collecting droplets comprising:
a) providing a reservoir comprising a second liquid that partially fills the reservoir; and
b) allowing droplets of a first liquid to contact the second liquid as the second liquid is moved, wherein the droplets move therefrom, and the first and second liquids are immiscible with each other.

95. The method of claim 94, wherein the reservoir is rotated.

96. The method of claim 94, wherein the reservoir comprises a trough having an inlet and an outlet and the second liquid flows from the inlet to the outlet.

97. The method of claim 96, wherein the flow rate of the second liquid is from about 150 μL/min to about 115 L/min.

98. The method of claim 94, wherein the rate of rotation of the reservoir is from about 0.05 MHz to about 150 MHz.

99. The method of claim 94, wherein the first liquid is less dense than the second liquid.

100. The method of claim 94, wherein the first liquid comprises particles.

101. The method of claim 100, wherein the particles comprise beads or biological particles.

102. The method of claim 94, wherein the reservoir comprises a cone trough.

103. The method of claim 94, wherein the second liquid is rotated into a vortex.

104. The method of claim 94, wherein the droplets move radially outwardly.

105. A method of producing droplets comprising:
(a) providing a device comprising a first channel having an outlet;
(b) transporting a liquid through the outlet; and
(c) pulsing electromagnetic energy to evaporate a portion of the liquid to produce droplets.

106. The method of claim 105, wherein electromagnetic energy originates from a source comprising a laser, a light-emitting diode (LED), or a broadband light source.

107. The method of any one of claims 105 and 106, wherein the source of electromagnetic energy has an output wavelength between about 100 nm and about 1,000,000 nm.

108. The method of any one of claims 105-107, wherein the source of electromagnetic energy has an output power density from about 1 W/mm² to about 1,000 W/mm².

109. The method of any one of claims 105-108, wherein the source of electromagnetic energy has an output pulse frequency from about 0.1 Hz to about 1,000,000 Hz.

110. The method of any one of claims 105-109, wherein the droplets are produced at a rate of at least 10 droplets per second.

111. The method of claim 105, wherein the device comprises a plurality of first channels, each having an outlet, and step b) comprises transporting a liquid through the outlet of each of the plurality of channels.

112. The method of claim 111, wherein the plurality comprises 2, 3, 4, 5, 6, 7, 8, 9, or 10 channels.

113. The method of any one of claims 105-112, wherein the liquid comprises an electromagnetic energy-absorbing material.

114. The method of claim 113, wherein the electromagnetic energy-absorbing material generates heat by absorbing electromagnetic energy.

115. The method of any one of claims 105-114, wherein the device further comprises a cladding around the channel to direct the electromagnetic energy to the outlet.

116. A method of decreasing the size of droplets comprising:
(a) providing droplets having a flow velocity;
(b) synchronizing a source of electromagnetic energy to the flow velocity; and
(c) pulsing electromagnetic energy from the source to evaporate at least a portion of the droplets, thereby reducing the size of the droplets.

117. The method of claim 116, wherein the droplets are generated using the method of any one of claims 1-11.

118. The method of any one of claims 116 and 117, wherein the flow velocity is from about 0.01 m/s to about 10 m/s.

119. The method of any one of claims 116-118, wherein the source of electromagnetic energy comprises a laser, a light-emitting diode (LED), or a broadband light source.

120. The method of any one of claims 116-119, wherein the source of electromagnetic energy has an output wavelength from about 100 nm to about 1,000,000 nm.

121. The method of any one of claims 116-120, wherein the source of electromagnetic energy has an output power density from about 1 W/mm² to about 1,000 W/mm².

122. The method of any one of claims 116-121, wherein the source of electromagnetic energy has an output pulse frequency from about 0.1 Hz to about 1,000,000 Hz.

123. The method of any one of claims 116-122, wherein the droplets comprise an electromagnetic energy-absorbing material.

124. The method of claim 123, wherein the electromagnetic energy-absorbing material generates heat by absorbing electromagnetic energy.

125. The method of any one of claims 116-124, wherein the droplets comprise a solvent and a solute, and decreasing the size of the droplets leads to an increase in the concentration of the solute.

126. The method of any one of claims 116-125, further comprising identifying a droplet to be removed.

127. The method of any one of claims 116-126, wherein the liquid in the droplet is substantially evaporated.

128. A system for producing droplets or decreasing the size of droplets, the system comprising a device comprising a first channel having an inlet and an outlet and a source of electromagnetic energy disposed to illuminate liquid or droplets exiting the outlet.

129. The system of claim 128, wherein the source of electromagnetic energy is disposed to pulse electromagnetic energy onto liquid transported through the outlet to produce droplets of the liquid.

130. The system of claims 128 and 129, wherein the device further comprises a cladding around the first channel to direct the electromagnetic energy to the outlet.

131. The system of any one of claims 128-130, wherein the source of electromagnetic energy comprises a laser, a light-emitting diode (LED), or a broadband light source.

132. The system of any one of claims 128-131, wherein the source of electromagnetic energy has an output wavelength from about 100 nm to about 1,000,000 nm; an output power density from about 1 W/mm² to about 1,000 W/mm²; and/or an output pulse frequency from about 0.1 Hz to about 1,000,000 Hz.

133. The system of any one of claims 128-132, further comprising a detector disposed to detect droplets.

134. The system of any one of claims 128 and 130-133, wherein the source of electromagnetic energy is disposed to pulse electromagnetic energy to decrease the size of droplets.
